(19) United States
(12) Patent Application Publication
(10) Pub. No.: US 2005/0153239 A1
(43) Pub. Date: Jul. 14, 2005

(54) Lithographic printing plate precursor and lithographic printing method using the same

(75) Inventors: Satoshi Hoshi, Haibara-gun (JP); Sumiaki Yamasaki, Haibara-gun (JP); Akio Oda, Haibara-gun (JP); Gaku Kumada, Haibara-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/023,544

(22) Filed: Dec. 29, 2004

(30) Foreign Application Priority Data
Jan. 9, 2004 (JP) P.2004-003950
Feb. 26, 2004 (JP) P.2004-051619

(51) Int. Cl. G03C 1/492

(52) U.S. Cl. 430/270.1

(57) ABSTRACT

A lithographic printing plate precursor comprises: a support; and an image recording layer that contains image forming particles and a non-water-soluble binder, the non-water-soluble binder interacting with the surface of the image forming particles. A lithographic printing plate precursor comprises: a support; and an image recording layer that contains a polymer binder and particles, wherein the particles are microcapsules having a polymerizable functional group as a wall material.

### BACKGROUND OF THE INVENTION

1. Field of the Invention

The present invention relates to a lithographic printing plate precursor and a lithographic printing method using the precursor. More specifically, the invention pertains to a lithographic printing plate precursor which can be made directly by scanning with an infrared laser according to digital signals from a computer or the like, and a lithographic printing method using the precursor.

2. Description of the Related Art

Lithographic printing plates are generally composed of lipophilic image areas which are receptive to an ink and hydrophilic non-image areas which are receptive to fountain solution during the printing procedure. Lithographic printing is a printing method of, by utilizing the mutually repelling property of water and an oil-based ink, causing a difference in the adhesion of a printing ink to the surface of a lithographic printing plate with a lipophilic image area as an ink receptive area and a hydrophilic non-image area as a fountain solution receptive area (ink non-receptive area); depositing the printing ink only on the image area; and then transferring the printing ink to a printing substrate such as paper.

In order to form this lithographic printing plate, lithographic printing plate precursors (PS plates) obtained by disposing a lipophilic photosensitive resin layer (image recording layer) over a hydrophilic support have conventionally been employed widely. It is the common practice to make a lithographic printing plate by exposing a lithographic printing plate precursor to light through an original on lith film, and leaving an image recording layer in an image area while dissolving and removing the image recording layer in a non-image area by an alkaline developer or organic solvent to expose the surface of the hydrophilic support.

The conventional plate making process of a lithographic printing plate precursor has required a step of, after exposure, dissolving and removing a non-image area by the development treatment with a developer suited for an image recording layer is necessary. One of the themes for plate making is to eliminate or simplify such ancillary wet treatment.

In particular, the disposal of waste water discharged upon wet treatment has a serious concern in the whole industry out of consideration to the global environment. There is therefore an increasing demand for overcoming the above-described problem.

As one simple plate making method devised in response to the above need, proposed is a method called “on-press development” (treatment-free type) in which a lithographic printing plate is obtained by using an image recording layer which permits removal of a non-image area of a lithographic printing plate precursor in an ordinary printing step, and removing the non-image area on a printing press after exposure.

Specific examples of the on-press development method include a method of using a lithographic printing plate precursor having an image recording layer which can be dissolved or dispersed in fountain solution, an ink solvent or an emulsion of fountain solution and a printing ink; a method of mechanically removing the image recording layer by bringing it into contact with the roller or blanket cylinder on a printing press; and a method of weakening a cohesive force of the image recording layer or adhesive force between the image recording layer and the support by the penetration of fountain solution or ink solvent, and then bringing the image recording layer into contact with a roller or blanket cylinder to mechanically remove the image recording layer.

Unless otherwise specifically indicated, the term “development treatment” as used herein refers to an operation in which, by using an apparatus (usually, an automatic developing machine) other than a printing press, a liquid (usually, an alkaline developer) is brought into contact with the lithographic printing plate precursor to remove therefrom the unexposed portion of the image recording layer and expose the surface of a hydrophilic support. The term “on-press development”, on the other hand, refers to a process and step in which, by using a printing press, a liquid (usually, a printing ink and/or fountain solution) is brought into contact with the lithographic printing plate precursor to remove therefrom the unexposed portion of the image recording layer and expose the surface of a hydrophilic support.

In recent years, digitizing technology to electronically process, store and output image data by using a computer has been employed widely, and various new image output systems suited to such digitizing technology have been put into practical use. Under such a tendency, attention has come to be paid on computer-to-plate technology capable of causing a highly convergent beam of radiation such as laser light to carry digitized image data thereon and subjecting the lithographic printing plate precursor to scanning exposure to the light, thereby directly producing a lithographic printing plate without using a lith film. It is therefore one of important technical themes to develop a lithographic printing plate suited for such technology.

In recent years, as described above, simpler plate making operations with dry system or without development treatment have been desired more eagerly from the viewpoints of consideration to the global environment and adaptation to digitizing.

When the conventional image recording system utilizing a light of from ultraviolet to visible regions is used for simplification of the plate making operations such as on-press development, however, the image recording layer is not fixed even after exposure and has photosensitivity to an indoor light It was therefore necessary to maintain a lithographic printing plate precursor under a light shielded condition after it was taken out from a package until the completion of the on-press development.

Since high-output lasers such as semiconductor laser or YAG laser which emits an infrared ray having a wavelength of from 760 to 1200 nm is available at a low cost, a method using such a high-output laser as a light source for image recording has come to be regarded as promising as a manufacturing method of a lithographic printing plate by scanning exposure which can readily be integrated with digitizing technology.

In the conventional plate making method utilizing a light of from ultraviolet to visible regions, the imagewise exposure of a photosensitive lithographic printing plate is carried out at a low to moderate illuminance, and the image is recorded by imagewise changes in physical properties brought about by photochemical reactions within the image recording layer. In the above-described method using a high-output laser, on the other hand, a region to be exposed is irradiated with a large amount of light energy for a very short period of time, the light energy is efficiently converted into thermal energy, and the resulting heat causes a chemical change, phase change and a change in form or structure within the image recording layer. Such changes are used for recoding images. Thus, the image data are input by light energy such as laser light, but the image is recorded using both light energy and reactions triggered by thermal energy. The recording method making use of heat generated by such high power density exposure is generally called “heat mode recording” and the conversion of light energy to heat energy is generally called “photothermal conversion.”

The major advantages of the plate making method using heat mode recording reside in that the image recording layer is not sensitized by light at an ordinary illuminance level such as indoor lighting and that the image recorded with high-illuminance exposure does not need fixing. In other words, before exposure, there is no danger of the lithographic printing plate precursor to be used in heat mode recording being sensitized to indoor light and after exposure, fixing of an image is not essential. Accordingly, for example, it is expected to become possible to establish a printing system free from the influence of exposure of an image to environmental lighting in the room after exposure to light from a high-output laser when a plate making step—comprising using a recording layer which is made insoluble or soluble by exposure to a high-output laser and making the imagewise exposed image recording layer into a lithographic printing plate—is performed by the on-press development. The realization of such a system is desired.

As such a lithographic printing plate precursor, that having an image formation layer obtained by dispersing hydrophobic thermoplastic polymer particles in a hydrophilic binder is known (for example, refer to Japanese Patent No. 2938397). This lithographic printing plate precursor permits the on-press development by, after exposure to an infrared laser, causing hydrophobic thermoplastic polymer particles to fuse and coalesce each other to form an image, mounting the precursor on the cylinder of a printing press and feeding it with fountain solution and/or printing ink.

Although the above-described method of forming an image by simple thermal fusion and coalescence of polymer fine particles exhibits good on-press developability, it involves such drawbacks as remarkably weak image strength and insufficient printing durability.

As a lithographic printing plate precursor permitting the on-press development and having improved printing durability, proposed is a precursor obtained by disposing, on a hydrophilic support, a heat-sensitive layer containing microcapsules having a thermoreactive-functional-group-containing compound encapsulated therein, wherein the heat-sensitive layer or a layer adjacent thereto contains an infrared absorber (refer to Japanese Patent Laid-Open No. 2001-277740 or Japanese Patent Laid-Open No. 2001-277742).

As another lithographic printing plate precursor permitting the on-press development and having improved printing durability, known is that having, on a support, a photosensitive layer containing an infrared absorber, a radical polymerization initiator, and a polymerizable compound (refer to Japanese Patent Laid-Open No. 2002-287334).

There is however a demand for further improvement in the printing durability and on-machine developability of conventional lithographic printing plate precursors.

### SUMMARY OF THE INVENTION

Based on the prior art, the present invention has been made. An object of the present invention is to provide a lithographic printing plate precursor which can carry out image recording by using an infrared emitting laser, record images directly from digital data of a computer or the like and carry out on-press development without development treatment, and provide a large number of good impressions at a practical energy amount, in short, a lithographic printing plate precursor excellent in on-press developability and printing durability; and a lithographic printing method using the lithographic printing plate precursor.

The present invention will next be described.

(1) A lithographic printing plate precursor comprising: a support; and an image recording layer that contains image forming particles and a non-water-soluble binder, the non-water-soluble binder interacting with the surface of the image forming particles.

(2) A lithographic printing plate precursor according to (1), wherein each of the image forming particles comprises a particle dispersant adjacent to the surface of said each of the the image forming particles, the particle dispersant interacting with the non-water-soluble binder.

(3) A lithographic printing plate precursor according to (1) or (2), wherein the image forming particles are microcapsules.

(4) A lithographic printing plate precursor according to (3), wherein each of the microcapsules internally contains a thermoreactive-group-containing compound and an infrared absorber.

(5) A lithographic printing plate precursor according to any one of (1) to (4), wherein the non-water-soluble binder is an organic polymer.

(6) A lithographic printing plate precursor according to (5), wherein the organic polymer comprises a polar substituent.

(7) A lithographic printing plate precursor according to any one of (2) to (6), wherein a difference in the I/O value between the particle dispersant and the organic polymer is 1.6 or less.

(8) A lithographic printing plate precursor according to any one of (1) to (7), which can be developed on a printing press by at least one of a printing ink and fountain solution.

(9) A lithographic printing plate precursor comprising: a support; and an image recording layer that contains a polymer binder and particles, wherein the particles are microcapsules having a polymerizable functional group as a wall material.

(10) A lithographic printing plate precursor according to (9), wherein the image recording layer further comprises an infrared absorber, a polymerization initiator and a polymerizable compound, in which the image recording layer permits imagewise recording by exposure to an infrared laser so as to form an exposed area and an unexposed area, and wherein printing is performed by removing, after imagewise exposing, the unexposed area by feeding an oil based ink and an aqueous component.

(11) A lithographic printing plate precursor according to (9) or (10), wherein the polymer binder has a polymerizable functional group.

(12) A lithographic printing method comprising: mounting a lithographic printing plate precursor according to any of (1) to (11) on a printing press; imagewise exposing the lithographic printing plate precursor with an infrared laser to form an exposed portion and an unexposed portion; feeding at least one of an printing ink and aqueous component to the lithographic printing plate precursor, to remove the unexposed portion; and starting printing.

It is noted that the mounting of the lithographic printing plate precursor to the printing press may be performed either before or after the imagewise exposing of the lithographic printing plate precursor.

The followings are more preferred embodiments of the invention.

(13) A lithographic printing plate precursor according to any one of (1) to (4) and (8), wherein the non-water-soluble binder is an inorganic polymer.

(14) A lithographic printing plate precursor according to (13), wherein the non-water-soluble binder is a particulate inorganic polymer having a hydrophobized surface.

### DETAILED DESCRIPTION OF THE INVENTION

The present invention will hereinafter be described more specifically.

[Lithographic Printing Plate Precursor]

There are two modes for carrying out the invention. One mode is that an image recording layer contains at least a binder and particles, the particles are image forming particles, and the binder is a non-water-soluble binder which interacts with the surface of the image forming particles (the mode of the image recording layer (1)). The other mode is that am image recording layer contains at least a binder and particles, the particles are microcapsules having, as the wall material thereof, a polymerizable functional group, and the binder is a polymer binder (the mode of the image recording layer (2)).

Image Recording Layer (1)

The image recording layer (1) contains at least a binder and particles. The particles are image forming particles (B), while the binder is a non-water-soluble binder (A) having a mutual action with the surface of the image forming particles.

Preferably, the image recording layer (1) further contains an infrared absorber (C), a polymerization initiator (D) and a polymerizable compound (E).

Each constituent of the image recording layer (1) will next be explained.

(A) Non-Water-Soluble Binder

As the non-water-soluble binder having a mutual action with the surface of the image forming particles, non-water-soluble organic polymer and inorganic polymer having film properties are preferred. Examples of such an organic polymer include acrylic resins, methacrylic resins, polyvinyl acetal resins, polyurethane resins, polyurea resins, polyimide resins, polyamide resins, epoxy resins, polystyrene resins, novolac phenolic resins, polyester resins, synthetic rubbers and natural rubbers, of which the acrylic resins and methacrylic resins are more preferred.

The organic polymer preferably has a recurring unit with a polar substituent in order to control the I/O value. As the polar substituent, hydrophilic ones are preferred and specific examples include hydroxyl group, carboxyl group, carboxylate group, ester group, poly(oxyethylene) group, poly(oxypropylene) group, amino group, ammonium group, amide group, sulfonic acid group, phosphoric acid group, alkoxy group, alkylcarbonyloxy group, phenylcarbonyloxy group, aklylcarbonylalkylcarbonyloxy group, alkylcarbonylamino group, alkylcarbonylaminoalkyloxycarbonylamino group, alkylcarbonylaminoalkylaminocarbonylamino group, cyano group, lactone group, ether group, urethane group, urea group and carbonate group.

The organic polymer may be a homopolymer available by the polymerization of a monomer having a polar substituent or a copolymerized polymer using at least two monomers in combination. The I/O value can be controlled by the kind of the polar substituent or copolymerization ratio. As the organic polymer, the copolymerized polymer is more preferred. Examples of the copolymerized polymer include copolymerized polymers obtained by the copolymerization of at least two acrylate or methacrylate ester monomers, at least one of which has the above-described polar substituent; copolymerized polymers obtained by the copolymerization of an acrylate or methacrylate ester monomer and an acrylic or methacrylic acid amide monomer, at least one of which has the above-described polar substituent; and the copolymerized polymers obtained by the copolymerization of an acrylate or methacrylate ester monomer and a styrene monomer, at least one of which has the above-described polar substituent.

The organic polymer preferably has crosslinkability in order to improve the film strength of an image area. To impart the organic polymer with crosslinkability, a crosslinkable functional group such as ethylenically unsaturated bond may be introduced into the main chain or side chain of the polymer. The crosslinkable functional group may be introduced by copolymerization.

Examples of the organic polymer having, in the main chain thereof, an ethylenically unsaturated bond include poly-1,4-butadiene and poly-1,4-isoprene.

Examples of the organic polymer having, in the side chain thereof, an ethylenically unsaturated bond include polymers of an acrylic or methacrylic acid ester or amide, and having, an ethylenically unsaturated bond as the ester or amide residue (R of —COOR or —CONHR).

Examples of the residue (the above-mentioned “R”) having an ethylenically unsaturated bond include —(CH₂)ₙ—CR₁═CR₂R₃, —(CH₂O)ₙCH₂—CR₁═CR₂R₃, —(CH₂—CH₂—O)ₙ—CH₂—CR₁═CR₂R₃, —(CH₂)ₙ—NH—CO—O—CH₂—CR₁═CR₂R₃, —(CH₂)ₙ—O—CO—CR₁═CR₂R₃ and —(CH₂ CH₂—O)₂-X (wherein R₁ to R₃ each represents a hydrogen atom, a halogen atom, or a C₁₋₂₀ alkyl, aryl, alkoxy or aryloxy group, or R₁ may be coupled with R₂ or R₃ to form a ring; n stands for an integer from 1 to 10; and X represents a dicyclopentadienyl residue). Specific examples of the ester residue include —CH₂CH═CH₂ (as described in Japanese Patent Publication No. 21633/1995), —CH₂—CH₂-O—CH₂—CH═CH₂, —CH₂—C(CH₃)═CH₂, —CH₂—CH═CH—C₆H₅, —CH₂—CH₂—OCO—CH═CH—C₆H₅, —CH₂—CH₂—NH—COO—CH₂—CH═CH₂ and —CH₂—CH₂—O—X (wherein X represents a dicyclopentadienyl residue).

Specific examples of the amide residue include —CH₂—CH═CH₂, —CH₂—CH₂—Y (wherein Y represents a cyclohexene residue) and —CH₂—CH₂—OCO—CH═CH₂.

The organic polymer having crosslinkability is cured, for example, by the addition, to the crosslinkable functional group thereof, of a free radical (polymerization initiating radical, or propagation radical during polymerization of a polymerizable compound) to effect addition polymerization, either directly between polymers or via polymerized chains of the polymerizable compound. Alternatively, the organic polymer having crosslinkability is cured in the following manner: atoms in the polymer (e.g., a hydrogen atom on the carbon atom adjacent to the crosslinkable functional group) are drawn by free radicals, and polymer radicals thus formed bond to each other to form a crosslink between the polymer molecules.

The content of the crosslinkable group in the organic polymer (content of radical-polymerizable unsaturated double bond, as determined by iodine titration) is preferably from 0.1 to 10.0 mmol, more preferably from 1.0 to 7.0 mmol, especially preferably from 2.0 to 5.5 mmol, per gram of the organic polymer. Within this range, good sensitivity and good storage stability can be attained.

From the viewpoint of the improvement in the on-press developability of the unexposed area of the image recording layer, the organic polymer preferably has high solubility or dispersibility in a printing ink and/or fountain solution. To improve the solubility or dispersibility in a printing ink, the organic polymer is preferably lipophilic, while to improve the solubility or dispersibility in fountain solution, the organic polymer is preferably hydrophilic. In the present invention, therefore, combined use of a lipophilic organic polymer and a hydrophilic organic polymer is also effective.

The organic polymer preferably has a weight average molecular weight of 5000 or greater, more preferably within a range of from 10000 to 300000 and a number average molecular weight of 1000 or greater, more preferably within a range of from 2000 to 250000. Polydispersibility (weight average molecular weight/number average molecular weight) preferably falls within a range of from 1.1 to 10.

The organic polymer may be any one of a random polymer, block polymer and a graft polymer, but it may preferably be a random polymer.

The organic polymer can be synthesized in a manner known per se in the art. Examples of the solvent used upon synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethyleneglycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethylsulfoxide and water. These solvents may be used either singly or in combination.

As a radical polymerization initiator to be used upon synthesis of the organic polymer, known compounds such as azo initiators and peroxide initiators can be used.

The following are the specific examples of the organic polymer but the examples are not limited thereto.

| No. | Polymer structure | Composition ratio | I/O value |
|---|---|---|---|
| B-1 | 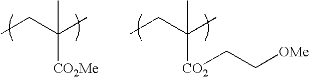 | 80/20 | 0.68 |
| B-2 | 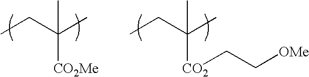 | 50/50 | 0.78 |
| B-3 | 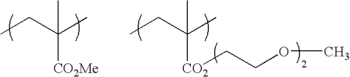 | 80/20 | 0.75 |
| B-4 | 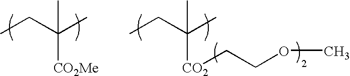 | 50/50 | 0.92 |
| B-5 | 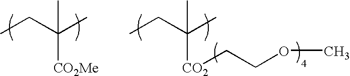 | 80/20 | 0.88 |
| B-6 | 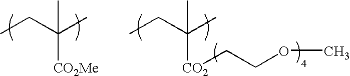 | 40/60 | 1.2 |
| B-7 | 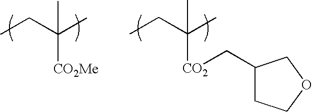 | 80/20 | 0.57 |
| B-8 | 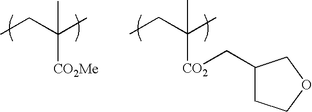 | 50/50 | 0.53 |
| B-9 | 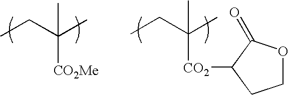 | 80/20 | 0.78 |
| B-10 | 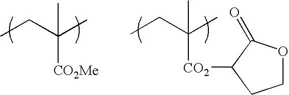 | 50/50 | 1.0 |
| B-11 | 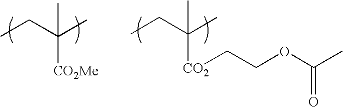 | 80/20 | 0.64 |
| B-12 | 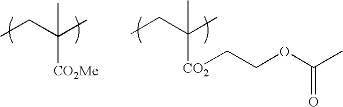 | 50/50 | 0.69 |
| B-13 | 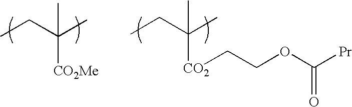 | 80/20 | 0.60 |
| B-14 | 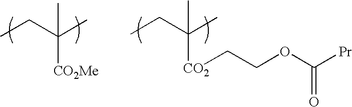 | 50/50 | 0.60 |
| B-15 | 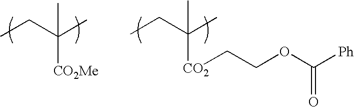 | 80/20 | 0.56 |
| B-16 | 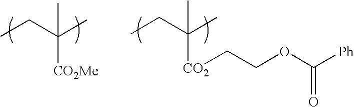 | 50/50 | 0.51 |
| B-17 | 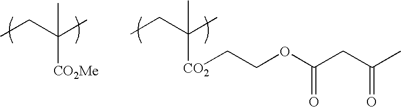 | 80/20 | 0.71 |
| B-18 | 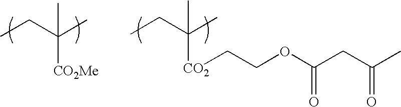 | 50/50 | 0.82 |
| B-19 | 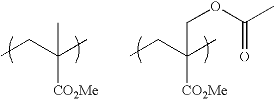 | 80/20 | 0.67 |
| B-20 | 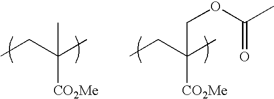 | 80/20 | 0.75 |
| B-21 | 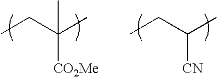 | 80/20 | 0.64 |
| B-22 | 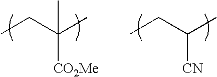 | 50/50 | 0.72 |
| B-23 | 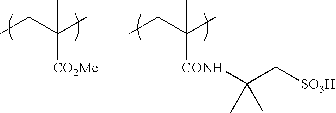 | 80/20 | 1.3 |
| B-24 | 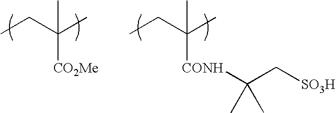 | 90/10 | 0.97 |
| B-25 | 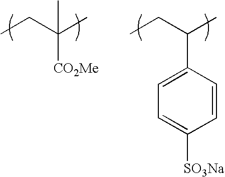 | 93/7 | 0.88 |
| B-26 | 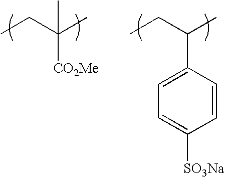 | 84/16 | 1.2 |
| B-27 | 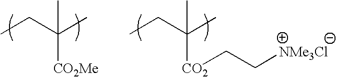 | 91/9 | 0.88 |
| B-28 | 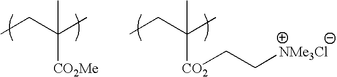 | 79/21 | 1.2 |
| B-29 | 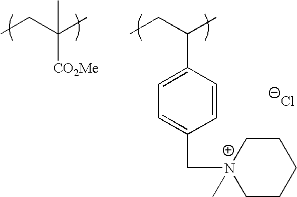 | 84/16 | 0.88 |
| B-30 | 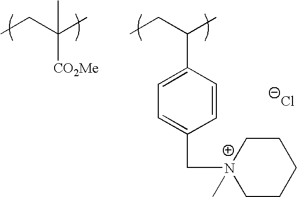 | 63/37 | 1.2 |
| B-31 | 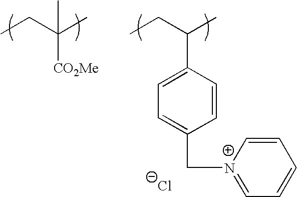 | 86/14 | 0.88 |
| B-32 | 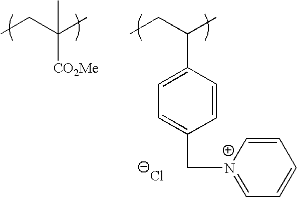 | 60/40 | 1.2 |
| B-33 | 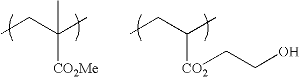 | 80/20 | 0.8 |
| B-34 | 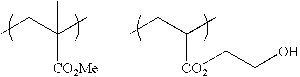 | 50/50 | 1.1 |
| B-35 | 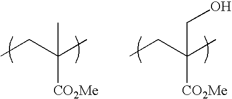 | 80/20 | 0.8 |
| B-36 | 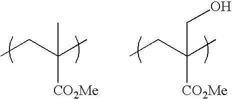 | 50/50 | 1.1 |
| B-37 | 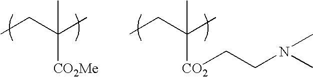 | 80/20 | 0.66 |
| B-38 | 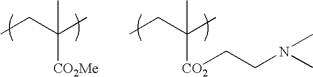 | 50/50 | 0.73 |
| B-39 | 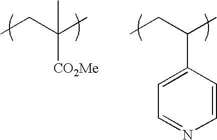 | 80/20 | 0.6 |
| B-40 | 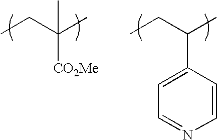 | 50/50 | 0.6 |
| B-41 | 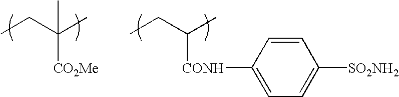 | 91/9 | 0.88 |
| B-42 | 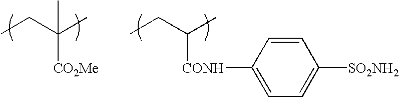 | 80/20 | 1.2 |
| B-43 | 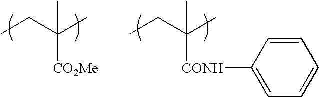 | 80/20 | 0.76 |
| B-44 | 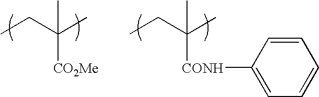 | 50/50 | 0.92 |
| B-45 | 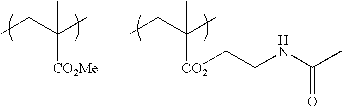 | 81/19 | 0.88 |
| B-46 | 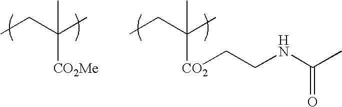 | 53/47 | 1.2 |
| B-47 | 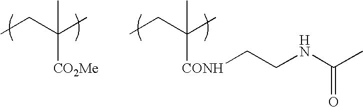 | 90/10 | 0.88 |
| B-48 | 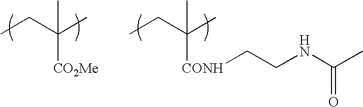 | 77/23 | 1.2 |
| B-49 | 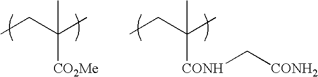 | 91/9 | 0.88 |
| B-50 | 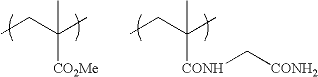 | 81/19 | 1.2 |
| B-51 | 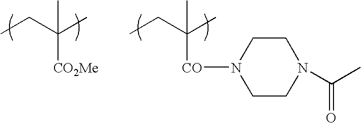 | 89/11 | 0.88 |
| B-52 | 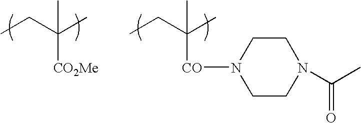 | 74/26 | 1.2 |
| B-53 | 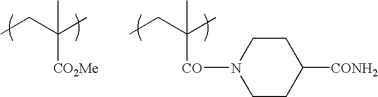 | 89/11 | 0.88 |
| B-54 | 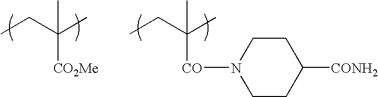 | 74/26 | 1.2 |
| B-55 | 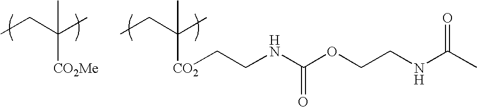 | 91/9 | 0.88 |
| B-56 | 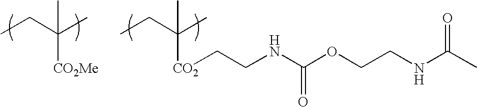 | 78/22 | 1.2 |
| B-57 | 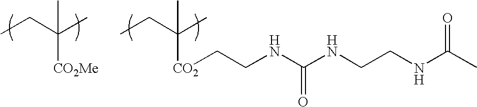 | 91/9 | 0.88 |
| B-58 | 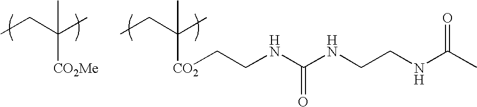 | 78/22 | 1.2 |
| B-59 | 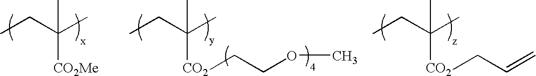 | 50/30/20 | 0.92 |
| B-60 | 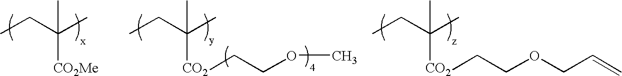 | 50/30/20 | 0.89 |
| B-61 | 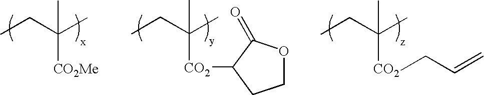 | 20/60/20 | 0.71 |
| B-62 | 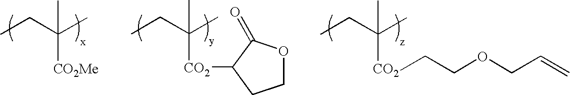 | 20/60/20 | 0.70 |
| B-63 | 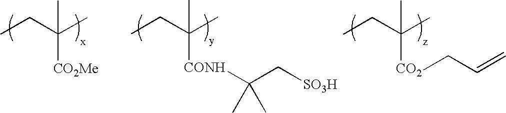 | 20/30/50 | 1.28 |
| B-64 | 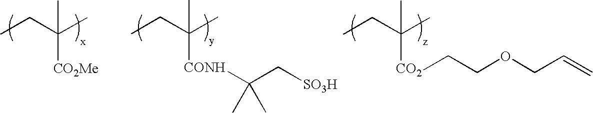 | 20/30/50 | 1.18 |
| B-65 | 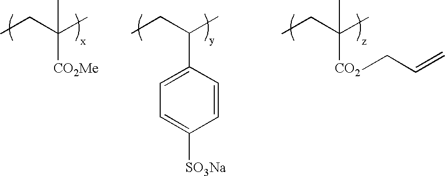 | 20/30/50 | 0.88 |
| B-66 | 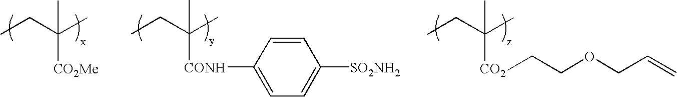 | 20/30/50 | 1.15 |

As the inorganic polymer, silica, titania, alumina and zirconia are preferred. They are preferably in the form of colloidal fine particles. Their particle size is preferably from 10 to 0.001 μm, more preferably from 5 to 0.002 μm, especially preferably from 1 to 0.005 μm. From the viewpoint of water resistance, they preferably have a hydrophobized surface. For this purpose, the surface may be treated with a hydrophobic silane coupling agent or colloid particles prepared using a coupling agent may be used.

Examples include “AEROSIL R972” (trade name of methyl-modified silica having an average particle size of 16 nm), “AEROSIL R974” (trade name of methyl-modified silica having an average particle size of 12 nm), “AEROSIL R805”. (trade name of octyl-modified silica having an average particle size of 12 μm), “AEROSIL R812” (trade name of trimethylsilyl-modified silica having an average particle size of 7 nm) and “AEROSIL T805” (trade name of an octyl-modified titanium dioxide having an average particle size of 21 nm), each product of Nippon Aerosil; and “TOSPEARL 105” (trade name of methyl-modified silica having an average particle size of 0.5 μm), “TOSPEARL 120” (trade name of methyl-modified silica having an average particle size of 2.0 μm), and “TOSPEARL 145” (trade name of methyl-modified silica having an average particle size of 4.5 μm), each product of Toshiba Silicones.

These non-water-soluble binders may be used either singly or in combination of two or more of them.

The content of the non-water-soluble binder is preferably from 10 to 90 mass % (mass % means wt % in this specification), more preferably from 20 to 80 mass/, especially preferably from 30 to 70 mass %, based on the whole solid content of the image recording layer. Within the above-described range, good strength at an image area and image forming properties can be attained.

The polymerizable compound (E) and non-water-soluble binder (A) are preferably used at a mass ratio of from 1/9 to 7/3.

(B) Image Forming Particles

As image forming particles to be used in the present invention, thermoplastic polymer particles, thermoreactive polymer particles, microcapsules with a hydrophobic compound encapsulated therein, self water-dispersible resin particles by the phase inversion emulsification method and self water-dispersible core-shell resin particles can be used.

Preferred examples of the thermoplastic polymer particles to be used in the image recording layer (1) of the invention include those as described in Research Disclosure No. 33303 (January 1992), Japanese Patent Laid-Open Nos. 123387/1997, 131850/1997, 171249/1997 and 171250/1997 and EP 931647. Examples of the polymer constituting such thermoplastic polymer particles include homopolymers or copolymers of ethylene, styrene, vinyl chloride, methyl acrylate, ethyl acrylate, methyl methacrylate, ethyl methacrylate, vinylidene chloride, acrylonitrile, vinyl carbazole or the like monomer, or mixtures of them. Of these, polystyrene and poly(methyl methacrylate) are more preferred.

The thermoplastic polymer particles to be used in the invention preferably have an average particle size of from 0.01 to 2.0 μm. Examples of the method for synthesizing such thermoplastic polymer particles include, in addition to emulsion polymerization and suspension polymerization, a method of dissolving such a compound in a non-water-soluble organic solvent, mixing the resulting solution with an aqueous solution containing a dispersant therein, emulsifying the mixture, and heating the resulting emulsion to evaporate the organic solvent while solidifying the residue into particles (dissolution-dispersion method).

Examples of the thermoreactive polymer particles usable in the invention include thermosetting polymer particles and polymer particles having a thermoreactive group.

Examples of the thermosetting polymer particles include resins having a phenolic skeleton, urea resins (for example, those obtained by resinifying urea or a derivative thereof such as methoxymethylated urea with an aldehyde such as formaldehyde), melamine resins (for example, those obtained by resinifying melamine or a derivative thereof with an aldehyde such as formaldehyde), alkyd resins, unsaturated polyester resins, polyurethane resins and epoxy resins. Of these, resins having a phenolic skeleton, melamine resins, urea resins and epoxy resins are preferred.

Preferred examples of the resins having a phenolic skeleton include phenolic resins obtained by resinifying phenol, cresol or the like with an aldehyde such as formaldehyde, hydroxystyrene resins, and polymers or copolymers of methacrylamide or acrylamide, or methacrylate or acrylate having a phenolic skeleton such as N-(p-hydroxyphenyl)methacrylamide or p-hydroxyphenyl methacrylate.

The thermosetting polymer particles to be used in the invention have preferably an average particle size of from 0.01 to 2.0 μm. Such thermosetting polymer particles are easily available by the dissolution-dispersion method. Alternatively, they may be obtained by pulverization upon synthesis of a thermosetting polymer. The preparation process is however not limited to them.

As the thermoreactive group of the polymer particles having a thermoreactive group which are to be used in the invention, any reactive functional group can be used insofar as it forms a chemical bond. Preferred examples include ethylenically unsaturated groups carrying out radical polymerization reaction (such as acryloyl, methacryloyl, vinyl and allyl); cationic polymerizable groups (such as vinyl and vinyloxy); isocyanate or blocked isocyanate groups which carry out an addition reaction; epoxy groups and vinyloxy groups, and active-hydrogen-atom-containing functional groups reactive therewith (such as amino group, hydroxyl group and carboxyl group); carboxyl groups which carry out a condensation reaction and hydroxyl or amino groups reactive therewith; and acid anhydrides which carry out a ring-opening addition reaction, and amino or hydroxyl groups reactive therewith.

These functional groups may be introduced into the polymer particles either during polymerization or after polymerization by utilizing a polymer reaction.

When the functional group is introduced during polymerization, it is preferable to subject the monomer having a functional group to emulsion polymerization or suspension polymerization. Specific examples of the monomer having a functional group include, but not limited to, allyl methacrylate, allyl acrylate, vinyl methacrylate, vinyl acrylate, 2-(vinyloxy)ethyl methacrylate, p-vinyloxystyrene, p-{2-(vinyloxy)ethyl}styrene, glycidyl methacrylate, glycidyl acrylate, 2-isocyanatoethyl methacrylate and isocyanates thereof blocked with an alcohol or the like, 2-isocyanatoethyl acrylate and isocyanates thereof blocked with an alcohol or the like, 2-aminoethyl methacrylate, 2-aminoethyl acrylate, 2-hydroxyethyl methacrylate, 2-hydroxyethyl acrylate, acrylic acid, methacrylic acid, maleic anhydride, bifunctional acrylate and bifunctional methacrylate.

In the invention, copolymers of the above-described monomer with a thermoreactive-group-free monomer copolymerizable therewith may be used. Examples of the thermoreactive-group-free monomer include styrene, alkyl acrylate, alkyl methacrylate, acrylonitrile and vinyl acetate. Any thermoreactive-group-free monomer can be used without limitation to them.

Examples of the polymer reaction used when introduction of the thermoreactive group is carried out after polymerization include the polymer reactions as described in International Publication 96/34316.

Of the polymer particles having a thermoreactive group, those which mutually coalesce under heating are preferred, with those having a hydrophilic surface and dispersible in water being especially preferred. It is desirable that a film formed by applying only the polymer particles and drying at a temperature lower than the solidification temperature has a contact angle (water drop in air) smaller than the contact angle (water drop in air) of a film formed in a similar manner except that the drying temperature is higher than the solidification temperature. In order to make the surface of the polymer particles hydrophilic, it is only necessary to cause a hydrophilic polymer or oligomer, or a hydrophilic low-molecular-weight compound such as polyvinyl alcohol or polyethylene glycol to adsorb to the surface of polymer particles. A method of making the surface hydrophilic is however not limited to it.

The solidification temperature of the polymer particles having a thermoreactive group is preferably 70° C. or greater, more preferably 100° C. or greater in consideration of the stability over time. The polymer particles preferably have an average particle size of from 0.01 to 2.0 μm, more preferably from 0.05 to 2.0 μm, most preferably from 0.1 to 1.0 μm. Within the above range, good resolution and good stability over time can be achieved.

The microcapsule to be used in the invention has a hydrophobic compound encapsulated therein. This hydrophobic compound is preferably a compound having a thermoreactive group. As the thermoreactive group, the above-described thermoreactive groups which have a thermoreactive group and are used for the polymer particles can be given as preferred examples. The microcapsule preferably has, in addition to the compound having a thermoreactive group, the below-described infrared absorber encapsulated therein. The compounds having a thermoreactive group will next be described more specifically.

Preferred examples of the compound having a radical polymerizable unsaturated group include compounds with at least one, preferably at least two ethylenically unsaturated bonds such as acryloyl, methacryloyl, vinyl and allyl groups. Such compounds are widely known as monomers or crosslinking agents for polymerizable compositions in the industrial fields related to the present invention. They can be used in the invention without any particular limitation. The chemical form of these compounds may be a monomer, a prepolymer, that is, oligomer including dimer and trimer, a polymer or copolymer, and a mixture thereof.

Specific examples include the compounds as described in Japanese Patent Laid-Open No. 2001-277740 as compounds having a polymerizable unsaturated group. Typical examples of such compounds include, but not limited to, trimethylolpropane di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol di(meth)acrylate, dipentaerythritol penta(meth)acrylate, dipentaerythritol hexa(meth)acrylate, and adducts of trimethylolpropane diacrylate and xylylene diisocyanate.

Examples of the compound, in the form of a polymer or copolymer, having an ethylenically polymerizable unsaturated group include copolymers of allyl methacrylate. Specific examples include allyl methacrylate/methacrylic acid copolymer, allyl methacrylate/ethyl methacrylate copolymer and allyl methacrylate/butyl methacrylate copolymer.

Preferred examples of the compound having a vinyloxy group include compounds as described in Japanese Patent Laid-Open No. 2002-29162. Specific examples include, but not limited to, tetramethylene glycol divinyl ether, trimethylolpropane trivinyl ether, tetraethylene glycol divinyl ether, pentaerythritol divinyl ether, pentaerythritol trivinyl ether, pentaerythritol tetravinyl ether, 1,4-bis{2-(vinyloxy)ethyloxy}benzene, 1,2-bis{2-(vinyloxy)ethyloxy}benzene, 1,3-bis{2-(vinyloxy)ethyloxy}benzene, 1,3,5-tris{2-(vinyloxy)ethyloxy}benzene, 4,4′-bis{2-(vinyloxy)ethyloxy}biphenyl, 4,4′-bis{2-(vinyloxy)ethyloxy}diphenyl ether, 4,4′-bis{2-(vinyloxy)ethyloxy}diphenylmethane, 1,4-bis{2-(vinyloxy)ethyloxy}naphthalene, 2,5-bis{2-(vinyloxy)ethyloxy}furan, 2,5-bis{2-(vinyloxy)ethyloxy}thiophene, 2,5-bis{2-(vinyloxy)ethyloxy}imidazole, 2,2-bis[4-{2-(vinyloxy)ethyloxy}phenyl]propane {the bis(vinyloxyethyl) ether of bisphenol A}, 2,2-bis{4-(vinyloxymethyloxy)phenyl}propane and 2,2-bis{4-(vinyloxy)phenyl}propane.

As the compound having an epoxy group, those having at least two epoxy groups are preferred. Examples include glycidyl ether compounds available by the reaction of a polyol or polyphenol with epichlorohydrin, or prepolymers thereof, and polymers or copolymers of glycidyl acrylate or glycidyl methacrylate.

Specific examples include propylene glycol diglycidyl ether, tripropylene glycol diglycidyl ether, polypropylene glycol diglycidyl ether, neopentyl glycol diglycidyl ether, trimethylolpropane triglycidyl ether, hydrogenated bisphenol A diglycidyl ether, hydroquinone diglycidyl ether, resorcinol diglycidyl ether, the diglycidyl ether or epichlorohydrin polyadduct of bisphenol A, the diglycidyl ether or epichlorohydrin polyadduct of bisphenol F, the diglycidyl ether or epichlorohydrin polyadduct of halogenated bisphenol A, the diglycidyl ether or epichlorohydrin polyadduct of biphenyl-type bisphenol, glycidyl etherification products of a novolac resin, methyl methacrylate/glycidyl methacrylate copolymer and ethyl methacrylate/glycidyl methacrylate copolymer.

Examples of the commercial available products of the above-described compounds include “Epikote 1001” (trade name; molecular weight: about 900; epoxy equivalent: 450 to 500), “Epikote 1002” (trade name; molecular weight: about 1,600, epoxy equivalent: 600 to 700), “Epikote 1004” (trade name; molecular weight: about 1,060, epoxy equivalent: 875 to 975), “Epikote 1007” (trade name; molecular weight: about 2,900, epoxy equivalent: 2,000), “Epikote 1009” (trade name; molecular weight: about 3,750, epoxy equivalent: 3,000), “Epikote 1010” (molecular weight; about 5,500, epoxy equivalent: 4,000), “Epikote 1100L” (trade name; epoxy equivalent: 4,000) and “Epikote YX31575” (epoxy equivalent: 1,200), each product of Japan Epoxy Resins; and “Sumiepoxy ESCN-195×HN”, “Sumiepoxy ESCN-195XL” and “Sumiepoxy ESCN-195XF” (each, trade name; product of Sumitomo Chemical).

Examples of the isocyanate compound suited for use in the invention include tolylene diisocyanate, diphenylmethane diisocyanate, polymethylene polyphenyl polyisocyanate, xylylene diisocyanate, naphthalene diisocyanate, cyclohexanephenylene diisocyanate, isophorone diisocyanate, hexamethylene diisocyanate, cyclohexyl diisocyanate, and compounds obtained by blocking any of the above-described compounds with an alcohol or amine.

Examples of the amine compound suited for use in the invention include ethylenediamine, diethylenetriamine, triethylenetetramine, hexamethylenediamine, propylenediamine and polyethyleneimine.

Examples of the hydroxyl-containing compound suited for use in the invention include compounds having a terminal methylol group, polyols such as pentaerythritol, and bisphenols polyphenols.

Examples of the carboxyl-containing compound suited for use in the invention include aromatic polycarboxylic acids such as pyromellitic acid, trimellitic acid and phthalic acid, and aliphatic polycarboxylic acids such as adipic acid.

Examples of the anhydride suited for use in the invention include pyromellitic anhydride and benzophenonetetracarboxylic anhydride.

For the microencapsulation of the above-described thermoreactive-group-containing compounds, known methods can be employed. Examples of the microcapsule preparing method include, but not limited thereto, the method of utilizing coacervation as described in U.S. Pat. Nos. 2,800,457 and 2,800,458, the methods using interfacial polymerization as described in GB Patent No. 990,443, U.S. Pat. No. 3,287,154, Japanese Patent Publication Nos. 19574/1963, 446/1967 and 711/1967, the methods using precipitation of a polymer as described in U.S. Pat. Nos. 3,418,250 and 3,660,304, the method using an isocyanate polyol wall material as described in U.S. Pat. No. 3,796,669, the method using an isocyanate wall material as described in U.S. Pat. No. 3,914,511, the method using a urea-formaldehyde or urea-formaldehyde-resorcinol wall-forming material as described in U.S. Pat. Nos. 4,001,140, 4,087,376 and 4,089,802, the method using a wall material such as melamine-formaldehyde resin and hydroxycellulose as described in U.S. Pat. No. 4,025,445, the in situ method using monomer polymerization as described in Japanese Patent Publication Nos. 9163/1961 and 9079/1976, the spray drying method as described in GB Patent No. 930,422 and U.S. Pat. No. 3,111,407; and the electrolytic dispersion cooling method as described in GB Patent Nos. 952,807 and 967,074.

A microcapsule wall preferably used in the invention has a three-dimensional crosslink structure and is swelled with a solvent. In order to satisfy these requirements, use of polyurea, polyurethane, polyester, polycarbonate or polyamide, or mixture thereof is preferred as the wall material of a microcapsule. Polyurea and polyurethane are especially preferred. A thermoreactive-group-containing compound may be introduced into a microcapsule wall.

The above-described microcapsule preferably has an average particle size of from 0.01 to 3.0 μm, more preferably from 0.05 to 2.0 μm, especially preferably from 0.10 to 1.0 μm. Within the above range, good resolution and good stability over time can be attained.

Such microcapsules may or may not mutually coalesce under heating. It is only necessary that a substance oozed onto the surface of the microcapsule or oozed out from the microcapsule or a substance which enters the microcapsule wall during application of the image recording layer may cause a chemical reaction under heating. The substance encapsulated in the microcapsule may react with a hydrophilic resin or a low-molecular-weight compound added. Alternatively, at least two microcapsules having functional groups, which are different and cause a thermal reaction each other, introduced therein may be reacted. Therefore, from the viewpoint of image formation, it is desirable, but not essential, for the microcapsules to melt and coalesce with each other by heating.

The amount of any one of the above-described polymer particles or microcapsules to be added to the image recording layer is preferably 50 mass % or greater, more preferably from 70 to 98 mass % in terms of a solid content, based on the total solid content in the image recording layer. Within this range, a good image can be formed and a long printing durability can be attained.

When the microcapsule is incorporated in the image recording layer of the invention, a solvent capable of dissolving therein the microcapsule contents and swelling the wall material therewith may be added to the microcapsule dispersing medium. Such a solvent promotes the diffusion, to the outside of the microcapsule, of the thermoreactive-group-containing compound encapsulated in the capsule. The kind of the solvent differs, depending on the microcapsule dispersing medium, the material making up the microcapsule wall, the thickness of the material used for the microcapsule wall, and the microcapsule contents, but may easily be selected from many commercially available solvents. For example, for water-dispersible microcapsules composed of a crosslinked polyurea or polyurethane wall, alcohols, ethers, acetals, esters, ketones, polyols, amides, amines and fatty acids are preferable as the solvent.

Specific examples of the solvent include methanol, ethanol, tertiary butanol, n-propanol, tetrahydrofuran, methyl lactate, ethyl lactate, methyl ethyl ketone, propylene glycol monomethyl ether, ethylene glycol diethyl ether, ethylene glycol monomethyl ether, γ-butyrolactone, N,N-dimethylformamide and N,N-dimethylacetamide. It is also possible to use two or more of these solvents in combination. Solvents which do not dissolve in the microcapsule dispersion, but dissolve therein by being mixed with the above-described solvent can also be used.

The amount of such a solvent is determined, depending on the combination of the raw materials employed, but usually addition in an amount of from 5 to 95 mass % is effective, with an amount of from 10 to 90 mass % being preferred and an amount of from 15 to 85 mass % being more preferred.

As an example of the particles to be used in the invention, hydrophobized resin fine particles obtained by introducing a hydrophilic group in the molecular structure of a resin forming image forming particles and thereby having a structure with a lipophilic resin as a self water-dispersible core portion and a hydrophilic component as a shell portion. Even if the resin particles do not exhibit self dispersing property, a variety of surfactants, water soluble resins and inorganic particles can be used as a particle dispersant for reinforcing dispersion stability.

Preferred examples of the self water-dispersible image forming particles include (1) resin fine particles obtained by dispersing, in water, a raw material resin having, in the molecule thereof, both a lipophilic resin portion and a hydrophilic group without using an emulsifier or protective colloid in accordance with the phase inversion emulsification method as described in Japanese Patent Laid-Open Nos. 221137/1991 or 66600/1993, and (2) resin fine particles having a core/shell structure in which a hydrophilic resin constitutes the core portion and a hydrophilic component constitutes the shell portion.

Examples of the hydrophilic group in the molecule of the raw material resin to be used in the phase inversion emulsification method include a carboxylic acid group, a sulfonic acid group, a phosphoric acid group, a hydroxyl group, an amide group, a sulfonamide group and an amino group. Specific examples of monomers having such a hydrophilic group include acrylic acid, methacrylic acid, crotonic acid, itaconic acid, maleic acid, fumaric acid, monobutyl itaconate, monobutyl maleate, acid phosphoxyethyl methacrylate, acid phosphoxypropyl methacrylate, 3-chloro-2-acrylamido-2-methylpropanesulfonic acid, 2-sulfoethyl methacrylate, acrylamide, N-vinylpyrrolidone, N-vinylimidazole and hydroxyethyl acrylate.

Examples of the lipophilic resin moiety in the molecule of the raw material resin used in the phase inversion emulsification method include polymer moieties available by polymerizing or copolymerizing the polymerizable monomer listed as the following (A) to (J).

(A) Acrylate esters. Examples of this monomer group include methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 2-hydroxyethyl acrylate, 4-hydroxybutyl acrylate, o-, m- or p-hydroxyphenyl acrylate, glycidyl acrylate and N,N-dimethylaminoethyl acrylate.

(B) Methacrylate esters. Examples of this monomer group include methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-cloroethyl methacrylate, 2-hydroxyethyl methacrylate, 4-hydroxybutyl methacrylate, o-, m- or p-hydroxyphenyl methacrylate, glycidyl methacrylate and N,N-dimethylaminoethyl methacrylate.

(C) Substituted acrylamides and substituted methacrylamides. Examples of this monomer group include N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide, N-(4-hydroxyphenyl) acrylamide and N-(4-hydroxyphenyl)methacrylamide.

(D) Vinyl ethers. Examples of this monomer group include ethyl vinyl ether, 2-chloroethyl vinyl ether, hydroxyethyl vinyl ether, propyl vinyl ether, butyl vinyl ether, octyl vinyl ether and phenyl vinyl ether.

(E) Vinyl esters. Examples of this monomer group include vinyl acetate, vinyl chloroacetate, vinyl butyrate and vinyl benzoate.

(F) Styrenes. Examples of this monomer group include styrene, methylstyrene, t-butylstyrene, chloromethylstyrene, o-, m- and p-hydroxystyrenes.

(G) Vinyl ketones. Examples of this monomer group include methyl vinyl ketone, ethyl vinyl ketone, propyl vinyl ketone and phenyl vinyl ketone.

(H) Olefins. Examples of this monomer group include ethylene, propylene, isobutylene, butadiene and isoprene.

(I) N-Containing monomers. Examples of this monomer group include N-vinylcarbazole, acrylonitrile and methacrylonitrile.

(J) Unsaturated Sulfonamide

Examples of this monomer group include acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide and N-(2-aminosulfonylethyl)acrylamide, methacrylamides such as N-(o-aminosulfonylphenyl)methacrylamide, N-(m-aminosulfonylphenyl)methacrylamide, N-(p-ammosulfonylphenyl)methacrylamide, N-[1-3-aminosulfonyl)naphthyl]methacrylamide and N-(2-aminosulfonylethyl)methacrylamide, acryliate esters such as o-aminosulfonylphenyl acrylate, m-aminosulfonylphenyl acrylate, p-aminosulfonylphenyl acrylate and 1-(3-aminosulfonylphenylnaphthyl) acrylate, and methacrylate esters such as o-aminosulfonylphenyl methacrylate, m-aminosulfonylphenyl methacrylate, p-aminosulfonylphenyl methacrylate and 1-(3-aminosulfonylphenylnaphthyl) methacrylate.

The lipophilic resin moiety in the molecule of the raw material resin to be used for the phase inversion emulsification method may be, in some cases, a copolymer of the above-described polymerizable monomer and a polymerizable-unsaturated-group-containing oligomer. Examples of the polymerizable-unsaturated-group-containing oligomer include vinyl modified polyesters, vinyl modified polyurethanes, vinyl modified epoxy resins and vinyl modified phenolic resins. Specific examples include those having a polymerizable unsaturated bond (vinyl group) introduced therein by the polycondensation or addition of various compounds such as maleic anhydride, fumaric acid, tetrahydrophthalic anhydride, endomethylene tetrahydromaleic anhydride, α-terpinene maleic anhydride adduct, and monoallyl ether, pentaerythritol diallyl ether or allyl glycidyl ether of triol.

An acid group can be introduced into a polyester only by the excessive use of a dibasic acid such as phthalic acid. The polyester having, at the terminal thereof, a carboxyl group can be obtained by this introduction. If trimellitic anhydride is used, the polyester having, in the main chain thereof, an acid group can be obtained.

The vinyl-modified polyurethane can be obtained by the addition polymerization of diisocyanate with various polyols such as glycerin monoallyl ether or butadiene polyol having a 1,2-bond. The vinyl bond may also be introduced by the addition reaction or the like of a urethane having, at the terminal thereof, an isocyanate group with a hydroxyl-containing polymerizable monomer. Alternatively, an acid component may be introduced into polyurethane by adding a polyol component such as dimethylolpropionic acid.

Examples of the vinyl modified epoxy resin include those obtained by reacting a terminal epoxy group of an epoxy resin with a carboxyl group of an acrylic or methacrylic acid.

Examples of the vinyl modified phenolic resin include those obtained by reacting a hydroxyl group of a phenolic resin with a (meth)acrylic acid halide or glycidyl (meth)acrylate.

An oligomer of a polymerizable monomer having a polymerizable vinyl group can be obtained by the addition of a glycidyl-containing polymerizable monomer to a carboxyl-containing vinyl copolymer. The polymerizable monomer usable in this reaction is selected from the above-described ones. Any oligomer having a polymerizable vinyl group can be used without being limited by the kind or preparation method, insofar as it has a polymerizable vinyl group.

A raw material resin for the self water-dispersible resin fine particles prepared in accordance with the phase inversion emulsification method is obtained by copolymerizing at least one oligomer selected from these monomers and polymerizable-unsaturated-group-containing oligomers with the above-described monomer having a hydrophilic group. This raw material resin preferably has a weight average molecular weight of from 500 to 500,000 and a number average molecular weight of from 200 to 60,000.

The raw material resin for the self water-dispersible resin fine particles may further have a thermoreactive functional group. Examples of the thermoreactive functional group include ethylenically unsaturated groups carrying out a polymerization reaction (for example, an acryloyl, methacryloyl, vinyl or allyl), an epoxy group carrying out an addition reaction, and an isocyanate group or a block form thereof. The introduction of the thermoreactive functional group has an effect of increasing the strength of an image area after exposure and improving the printing durability. The thermoreactive functional group may be introduced by a polymer reaction as described, for example, in WO96-34316.

Additional examples of the self water-dispersible resin fine particles to be used in the invention include urethane resins such as urethane resin dispersion as described in Japanese Patent Laid-Open No. 287183/1989, and epoxy resins such as a variety of epoxy compounds as described in Japanese Patent Laid-Open Nos. 1228/1978, 3481/1980 or 9433/1980.

The resin fine particles to be used in the invention are able to contain a hydrophobic organic low molecular compound in the fine particles in order to heightening their action of causing fusion, diffusion and leaching by the heat generated upon exposure to light and thereby hydrophobizing the vicinity of the particles.

Examples of such an organic low molecular compound include printing ink components, plasticizers, aliphatic or aromatic hydrocarbons having a high boiling point, carboxylic acid, alcohols, esters, ethers, amines and derivatives thereof.

Specific examples include oils and fats such as linseed oil, soybean oil, poppy oil and safflower oil, plasticizers such as tributyl phosphate, tricresyl phosphate, dibutyl phthalate, dibutyl laurate and dioctyl phthalate, fine particle dispersions of wax such as carnauba wax, castor wax, microcrystalline wax, paraffin wax, shellac wax, palm wax and beeswax, or metal salts of a long-chain fatty acid, such as low molecular weight polyethylene, silver behenate, calcium stearate and magnesium palmitate, n-nonane, n-decane, n-hexadecane, octadecane, eicosane, caproic acid, capric acid, stearic acid, oleic acid, dodecyl alcohol, octyl alcohol, n-octadecyl alcohol, 2-octanol, lauryl alcohol, lauryl methyl ether, stearyl methyl ether and stearylamide.

The hydrophobic organic compound can be incorporated in the image forming particles by adding, upon synthesis of resin fine particles, the resin fine particles to an organic solvent having the hydrophobized resin dissolved therein and performing the phase inversion emulsification.

The coagulation temperature of the self water-dispersible image forming particles is preferably 70° C. or greater. In view of the stability over time, 100° C. or greater is more preferred.

The self water-dispersible resin fine particles having a core/shell structure which are to be used in the invention are either core/shell type composite fine particles prepared by using, as a core, fine particles of a hydrophobic polymer—which have been obtained by the emulsification (including phase inversion emulsification) or dispersion polymerization and soften or melt by the action of heat—and forming a hydrophilic polymer layer around the core or hetero-phase structure fine particles which are simply called core-shell fine particles. The hydrophilic polymer layer is formed by adding a hydrophilic monomer to a dispersion of core particles (seed) and then polymerizing the hydrophilic monomer on the surface of the core particles.

The polymer constituting the core phase is at least one lipophilic resin selected from acrylic resins, epoxy resins, styrene resins, urethane resins, phenolic resins and vinyl ester resins, and derivatives thereof. More specifically, it can be selected from the resins described as a raw material resin used for the phase inversion emulsification method and the resin fine particles obtained by the phase inversion emulsification method.

The hydrophilic resin constituting the shell phase is a resin having at least one hydrophilic group selected from carboxylic acid group, sulfonic acid group, phosphoric acid group, hydroxyl group, amide group, sulfonamide group and amino group. As such a resin, resins as described in the synthesis process of the raw material resin molecule to be used for the phase inversion emulsification method, for example, copolymers of a monomer having such a hydrophilic group with the above-described polymerizable monomer (A) to (J) or a polymerizable unsaturated-group-containing oligomer can be given. In addition, various epoxy resins having a core/shell structure as described in Japanese Patent Laid-Open No. 9431/1993 are suited as the self water-dispersible image forming particles of the invention.

As well as the resin fine particles obtained by the phase inversion emulsification, the self water-dispersible image forming particles having a core/shell structure can also have a hydrophilic compound adsorbed to the resin surface or have a hydrophobic organic compound encapsulated in the resin. Compounds suited for adsorption or encapsulation are similar to those described above with regards to the resin fine particles in accordance with the phase inversion emulsification.

In order to reinforce the dispersion stability of the image forming particles of the invention, a water soluble resin, surfactant, or inorganic oxide or inorganic hydroxide particles can be used as a particle dispersant. Examples of the water soluble resin include polyvinyl alcohol (PVA), modified PVA such as carboxy-modified PVA, polyacrylamide and copolymers thereof, polydimethylacrylamide, polyacrylacetamide, polyoxazoline, acrylic acid copolymers, polyvinyl methyl ether, vinyl methyl ether/maleic anhydride copolymer, polyvinylpyrrolidone, vinyl acetate/crotonic acid copolymer, polyacrylic acid, water soluble urethane resins, polyethylene glycol, polypropylene glycol, N-vinylcarboxylic acid amide polymers, and polyethyleneimine. Of these, polyvinyl alcohol (PVA), polyacrylamide, polydimethylacrylamide, polyacrylacetamide, polyoxazoline, polyvinyl methyl ether, polyvinylpyrrolidone, polyacrylic acid, polyethylene glycol and polyethyleneimine are preferably employed, with highly hydrophilic resins being especially preferred. Polyvinyl alcohol having a saponification degree of 95% or greater is preferred. These water soluble resins may be used as a mixture of two or more of them.

The content of the water soluble resin in the polymer fine particles is adequately from 1 to 25 mass %, with a range of from 2 to 15 mass % being preferred.

Examples of the surfactant used for the image forming particles of the invention include, in addition to nonionic and anionic surfactants, cationic surfactants and fluorosurfactants as described in Japanese Patent Laid-Open No. 195356/1990, and amphoteric surfactants as described in Japanese Patent Laid-Open Nos. 121044/1984 and 13149/1992.

Specific examples of the nonionic surfactants include polyoxyethylene alkyl ethers such as polyoxyethylene lauryl ether, polyoxyethylene stearyl ether, polyoxyethylene cetyl ether and polyoxyethylene oleyl ether, polyoxyethylene alkylaryl ethers such as polyoxyethylene nonylphenyl ether, polyoxyethylene-polyoxypropylene block copolymers, composite polyoxyalkylene alkyl ethers obtained by the ether bonding of a C₅₋₂₄ aliphatic group to the terminal hydroxyl group of a polyoxyethylene-polyoxypropylene block copolymer, composite polyoxyalkylene alkylaryl ethers having an alkyl-substituted aryl group ether-bonded to the terminal hydroxyl group of polyoxyethylene-polyoxypropylene block copolymer, sorbitan fatty acid esters such as sorbitan monolaurate, sorbitan monostearate, sorbitan tristearate, sorbitan monopalmitate, sorbitan monooleate and sorbitan trioleate and polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan tristearate, polyoxyethylene sorbitan trioleate.

Specific examples of the anionic surfactants include alkylsulfonic acids, arylsulfonic acids, aliphatic carboxylic acids, alkylnaphthalenesulfonic acids, condensation products of an alkylnaphthalenesulfonic acid or naphthalenesulfonic acid with formaldehyde, C₉₋₂₆ aliphatic sulfonic acids, alkylbenzenesulfonic acids, and polyoxyethylene-containing sulfuric acids and polyoxyethylene-containing phosphoric acids such as lauryl polyoxyethylene sulfuric acid, cetyl polyoxyethylene sulfonic acid, and oleyl polyoxyethylene phosphonic acid.

Specific examples of the cationic surfactants include laurylamine acetate, lauryltrimethylammonium chloride, distearyldimethylammonium chloride, and alkylbenzyldimethylammonium chlorides. Specific examples of the fluorosurfactants include perfluoroalkyl carboxylate salts, perfluoroalkyl phosphate esters, perfluoroalkyltrimethylammonium salts, perfluoroalkylbetaines, perfluoroalkylamine oxides and perfluoroalkyl EO adducts.

Specific examples of the amphoteric surfactants include alkylcarboxybetaines, alkylaminocarboxylic acids, alkyldi(aminoethyl)glycine, alkylpolyaminoethylglycine hydrochloride, 2-alkyl-N-carboxyethyl-N-hydroxyethyl-imidazolinium betaine and N-tetradecyl-N,N-betaine (for example, “Amorgen K” (trade name; product of Daiichi Kogyo Seiyaku).

The content of the above-described surfactant in the polymer fine particles is adequately from 1 to 25 mass %, preferably from 2 to 15 mass %.

For the formation of the image forming particles of the invention, fine particles of an oxide or hydroxide of at least one element selected from the Group II to XV elements of the periodic table may be used. Specific preferred examples of the element include magnesium, titanium, zirconium, vanadium, chromium, zinc, aluminum, silicon, tin and iron. Of these, silicon, titanium, aluminum and tin are preferred. The fine particles of the oxide or hydroxide of the above-described element can be used as a colloid of the oxide or hydroxide and the fine particles have usually an average particle size of from 0.001 to 1 μm, preferably from 5 to 40 nm, most preferably from 10 to 30 nm. Commercially available products such as those of Nissan Chemical Industry can be used as a dispersion of such a colloid.

As a resin of the image forming particles using the above-described raw material, a resin containing an organosilicon group as described in Japanese Patent Laid-Open No. 2002-226597 is preferred. A resin having, in the structural unit thereof, a functional group, such as a titanate coupling group or aluminum coupling group, which can be chemically bonded to various inorganic particles may be used.

The image forming particles using the above-described raw materials can be prepared in a known manner. Described specifically, a desired water dispersion of polymer particles is available by preparing an oil phase solution having a hydrophobic polymer dissolved in a solvent immiscible with water and an aqueous phase solution containing oxide fine particles such as silica or hydroxide fine particles and a surfactant, mixing these solutions, stirring and mixing the resulting mixture vigorously at 12,000 rpm for 10 to 15 minutes by using an emulsifying dispersing machine such as homogenizer, thereby emulsifying and dispersing oil droplets in the aqueous phase, and heating and stirring the emulsified dispersion thus obtained to evaporate the solvent.

The content of the inorganic oxide fine particles or inorganic hydroxide fine particles in the polymer fine particles is adequately from 1 to 25 mass %, preferably from 2 to 15 mass %.

Mutual Action

The mutual action (interaction) of the non-water-soluble binder and the surface of the image forming particles is, for example, a mutual action by hydrogen bonding, mutual action by electrostatic affinity, mutual action by Van der Waals power, ionic mutual action or chelate mutual action.

As an index quantitatively expressing the degree of the mutual action between the non-water-soluble binder and the surface of the image forming particles, it is effective to compare the I/O value of the particle dispersant on the surface of the image forming particles with the I/O value of the non-water-soluble binder. The I/O value is defined by an organic conceptual view as described in “Yuli Gainenzu-Kiso to Oyo (Organicity Chart—Basics and Applications), written by Yoslio Koda, published by Sankyo Shuppan (1984) and it is a ratio of an inorganicity to an organicity of the compound. In this concept, the degree of the physicochemical properties of the compound mainly by Van der Waals force is called “organicity” and the degree of the physical properties mainly by an electric affinity is called “inorganicity”. Thus, the physical properties of the compound are grasped as a combination of “organicity” and “inorganicity”. According to this concept, the inorganicity is greater when the I/O value is higher and the organicity is higher when the I/O value is smaller. In comparison between of the I/O values of two compounds, they have similar properties and mutual action is greater when the difference between the I/O values is smaller, that is, their I/O values are closer.

In the invention, a difference in the I/O value between the surface of the image forming particles and non-water-soluble binder is preferably 1.6 or less, more preferably 1.2 or less, most preferably 1.0 or less.

(C) Infrared Absorber

When lithographic printing plate precursor is exposed to a laser emitting an infrared ray of 760 to 1200 nm as a light source in order to form an image, use of an infrared absorber is usually essential. The infrared absorber has a function of converting the infrared ray thus absorbed to heat The heat generated by this conversion causes thermal decomposition of a polymerization initiator (radical generator) which will be described later to generate radicals. The infrared absorber to be used in the invention is a dye or pigment having an absorption maxima in a wavelength range of from 760 to 1200 nm.

As the dye, commercially available dyes and known dyes as described in the literature, such as “Senryo Binran” (Handbook of Dyes) (ed. by The Society of Synthetic Organic Chemistry, 1970) can be used. Specific examples include azo dyes, metal complex salt azo dyes, pyrazolone azo dyes, naphthoquinone dyes, anthraquinone dyes, phthalocyanine dyes, carbonium dyes, quinonimine dyes, methine dyes, cyanine dyes, squarylium dyes, pyrylium salts, and metal-thiolate complexes.

Preferred examples of the dye include the cyanine dyes as described in Japanese Patent Laid-Open Nos. 125246/1983, 84356/1984, and 78787/1985; the methine dyes as described in Japanese Patent Laid-Open Nos. 173696/1983, 181690/1983 and 194595/1983; the naphthoquinone dyes as described in Japanese Patent Laid-Open Nos. 112793/1983, 224793/1983, 48187/1984, 73996/1984, 52940/1985 and 63744/1985; the squarylium dyes as described in Japanese Patent Laid-Open No. 112792/1983; and the cyanine dyes as described in GB Patent No. 434,875.

The near-infrared absorbing sensitizers as described in U.S. Pat. No. 5,156,938 can also be suited. Also preferred are substituted arylbenzo(thio)pyrylium salts as described in U.S. Pat. No. 3,881,924, the trimethinethiapyrylium salts as described in Japanese Patent Laid-Open No. 142645/1982 (U.S. Pat. No. 4,327,169), the pyrylium compounds as described in Japanese Patent Laid-Open Nos. 1810511/1983, 220143/1983, 41363/1984, 84248/1984, 84249/1984, 146063/1984 and 146061/1984; the cyanine dyes as described in Japanese Patent Laid-Open No. 216146/1984; the pentamethinethiopyrylium salts as described in U.S. Pat. No. 4,283,475; and the pyrylium compounds as disclosed in Japanese Patent Publication Nos. 13514/1993 and 19702/1993. As another preferred example of dye, the near-infrared absorbing dyes as described in U.S. Pat. No. 4,756,993 as compounds represented by the formulas (I) and (II) are also preferred.

As another preferred example of the infrared absorber to be used in the invention, specific indoleninecyanine dyes as described in Japanese Patent Laid-Open No. 2002-278057 can be given.

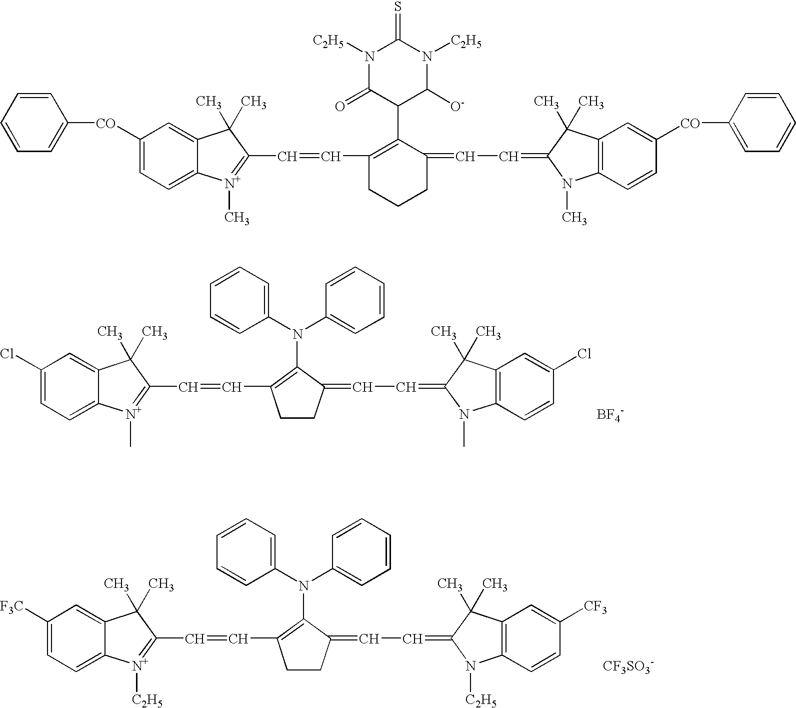

Of these dyes, cyanine dyes, squarylium dyes, pyrylium salts, nickel-thiolate complexes and indolenine cyanine dyes are especially preferred, of which the cyanine dyes and indolenine cyanine dyes are more preferred. The cyanine dye of the following formula (i) can be given as one of the most preferred dyes.

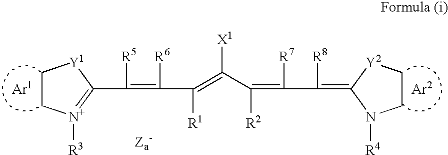

In the formula (i), X¹ represents a hydrogen atom, a halogen atom, —NPh₂, X²-L¹, or the following group and Ph represents a phenyl group. Here, X² represents an oxygen atom, a nitrogen atom, or a sulfur atom; and L¹ represents a C₁₋₁₂ hydrocarbon group, a hetero-atom-containing aromatic ring, or a hetero-atom-containing C₁₋₁₂ hydrocarbon group. The term “hetero atom” as used herein means N, S, O, a halogen atom, or Se. Xₐ⁻ has the same meaning as Zₐ⁻ which will be described later; and R^{a} represents a substituent selected from a hydrogen atom, alkyl groups, aryl groups, substituted or unsubstituted amino group, and halogen atoms.

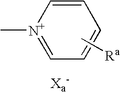

R¹ and R² each independently represents a C₁₋₁₂ hydrocarbon group. Preferably, R¹ and R² each represents a hydrocarbon group having 2 or more carbon atoms in view of storage stability of a recording layer coating solution; and especially preferably, R¹ and R² are coupled each other to form a 5-membered or 6-membered ring.

Ar¹ and Ar² may be the same or different and each represents a substituted or unsubstituted aromatic hydrocarbon group. Preferred examples of the aromatic hydrocarbon group include a benzene ring and a naphthalene ring. Preferred examples of the substituent include hydrocarbon groups having 12 or less carbon atoms, halogen atoms, and alkoxy groups having 12 or less carbon atoms. Y¹ and Y² may be the same or different and each represents a sulfur atom or a dialkylmethylene group having 12 or less carbon atoms. R³ and R⁴ may be the same or different and each represents a substituted or unsubstituted hydrocarbon group having 20 or less carbon atoms. Preferred examples of the substituent include alkoxy groups having 12 or less carbon atoms, carboxyl group, and sulfo group. R⁵, R⁶, R⁷, and R⁸ may be the same or different and each represents a hydrogen atom or a hydrocarbon group having 12 or less carbon atoms. Of these, a hydrogen atom is preferred in view of easy availability of the raw material. Also, Zₐ⁻ represents a counter anion, with the proviso that when the cyanine dye represented by the formula (i) has, in the structure thereof, an anionic substituent, and does not need neutralization of a charge, Zₐ⁻ is not necessary. Preferred examples of Zₐ⁻ include halogen ion, perchloric acid ion, tetrafluoroborate ion, hexafluorophosphate ion, and sulfonic acid ion, from the viewpoint of the storage stability of a recording layer coating solution. Of these, a perchloric acid ion, a hexafluorophosphate ion, and an arylsulfonic acid ion are especially preferred.

Specific examples of the cyanine dye represented by the formula (i) which can be suited for use in the invention include those as described in paragraphs [0017] to [0019] of Japanese Patent Laid-Open No. 2001-133969.

The specific indolenine cyanine dyes as described in the above-described Japanese Patent Laid-Open No. 2002-278057 can be given as another especially preferred example.

As the pigments to be used in the invention, commercially available pigments and pigments as described in Color Index (C.I.) Handbook; Saishin Ganryo Binran (Current Pigment Handbook, edited by Nippon Ganryo Pigment Kyokai, published in 1977); Saishin Ganryo Ohyo Gijutsu (Current Pigment Application Technologies, published by CMC Publishing Co., Ltd. in 1986); and Insatsu Inki Gijutsu (Printing Ink Technologies, published by CMC Publishing Co., Ltd. in 1984) can be used.

Examples of the pigment include black pigments, yellow pigments, orange pigments, brown pigments, red pigments, violet pigments, blue pigments, green pigments, fluorescent pigments, metal powder pigments, and other polymer-binding dyes. Specific examples include insoluble azo pigments, azo lake pigments, condensed azo pigments, chelate azo pigments, phthalocyanine pigments, anthraquinone pigments, perylene pigments, perinone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Of these pigments, carbon black is preferred.

The pigment may be used after surface treatment or without surface treatment. As the surface treatment, a method of coating the surface with a resin or a wax, a method of attaching a surfactant to the surface, and a method of binding a reactive substance (such as silane coupling agent, epoxy compound, or polyisocyanate) to the pigment surface can be considered. These surface treatment methods are described in “Kinzoku Sekken No Seishitsu To Ohyo” (Properties and Applications of Metallic Soaps, published by Saiwai Shobo), “Insatsu Inki Gijutsu” (Printing Ink Technologies, published by CMC Publishing Co., Ltd. in 1984); and Saishin Ganryo Ohyo Gijutsu (Current Pigment Application Technologies, published by CMC Publishing Co., Ltd. in 1986).

The particle size of the pigment preferably ranges from 0.01 μm to 10 μm, more preferably from 0.05 μm to 1 μm, especially preferably from 0.1 μm to 1 μm. Within the above-described range, the pigment dispersion in the image recording layer coating solution has good stability and the resulting recording layer has good uniformity.

As a method of dispersing the pigment, known dispersing techniques to be used in the ink production or toner production can be employed. Examples of dispersing machines include a ultrasonic dispersion machine, a sand mill, an attritor, a pearl mill, a super mill, a ball mill, an impeller, a disperser, a KD mill, a colloid mill, a dynatron, a three-roll mill, and a pressure kneader. The details are as described in Saishin Ganryo Ohyo Gijutsu (Current Pigment Application Technologies, published by CMC Publishing Co., Ltd. in 1986).

The above-described infrared absorber may be added in the layer containing the other components or may be added in another layer provided newly. Upon preparation of a negative lithographic printing plate precursor, the infrared absorber is added in such a manner that the absorbance at the maximum absorption wavelength in the wavelength range of the image recording layer of from 760 nm to 1,200 nm falls within a range of from 0.3 to 1.2, preferably from 0.4 to 1.1 by the reflection measurement method. Within this range, uniform polymerization reaction proceeds in the depth direction of the image recording layer and good film strength in an image area and good adhesion to a support can be attained.

The absorbance of the image recording layer can be adjusted according to the amount of the infrared absorber to be added to the image recording layer and the thickness of the image recording layer. The absorbance can be measured in a conventional manner. Examples of the measurement method include a method of forming, on a reflective support such as aluminum, an image recording layer having a thickness determined as needed so that the coating weight after drying falls within a necessary range as a lithographic printing plate, and measuring the reflection density using an optical densitometer, and a method of measuring the absorbance using a spectrophotometer by the reflection method using an integrating sphere.

(D) Polymerization Initiator

The polymerization initiator to be used in the invention means a compound capable of generating radicals by light, heat or both energy and initiating and promoting the polymerization of a compound having a polymerizable unsaturated group. In the invention, known thermal polymerization initiators, compounds having a bond which needs small energy for dissociation, and photopolymerization initiators can be used. Radical generating compounds preferably employed in the invention mean compounds generating radicals by heat energy and initiating and promoting the polymerization of a compound containing a polymerizable unsaturated group. As the heat radical generator relating to the invention, known polymerization initiators or compounds having a bond which needs small energy for dissociation can selectively be used as needed. The radical generating compounds may be used either singly or in combination.

Examples of the radical generating compound include organic halide compounds, carbonyl compounds, organic peroxide compounds, azo based polymerization initiators, azide compounds, metallocene compounds, hexaaryl biimidazole compounds, organic boric acid compounds, disulfonic acid compounds, oxime ester compounds and onium salt compounds.

Examples of the organic halogen compounds include the compounds as described in Wakabayashi et al., “Bull. Chem. Soc. Japan, 42, 2924(1969)”, U.S. Pat. No. 3,905,815, Japanese Patent Publication No. 4605/1971, Japanese Patent Laid-Open Nos. 36281/1973, 32070/1980, 239736/1985, 169835/1986, 169837/1986, 58241/1987, 212401/1987, 70243/1988, and 298339/1988, and M. P. Hutt, “Journal of Heterocyclic Chemistry, 1 (No. 3), (1970). In particular, oxazole compounds substituted with a trihalomethyl group and s-triazine compounds can be given as examples.

More preferred are s-triazine derivatives having an s-triazine ring to which at least one mono-, di- or tri-halogen-substituted methyl group has been bonded. Specific examples of such an s-triazine derivative include 2,4,6-tris(monochloromethyl)-s-triazine, 2,4,6-tris(dichloromethyl)-s-triazine, 2,4,6-tris(tri-chloromethyl)-s-triazine, 2-methyl-4,6-bis(trichloromethyl)-s-triazine, 2-n-propyl-4,6-bis (trichloromethyl)-s-triazine, 2-(α,α,β-trichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis-(trichloromethyl)-s-triazine, 2-(p-methoxystyryl)-4,6-bis-(trichloromethyl)-s-triazine, 2-(p-1-propyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethy)-s-triazine.

Examples of the carbonyl compounds include benzophenone derivatives such as benzophenone, Michler's ketone, 2-methylbenzophenone, 3-methylbenzophenone, 4-methylbenzophenone, 2-chlorobenzophenone, 4-bromo-benzophenone, and 2-carboxybenzophenone; acetophenone derivatives such as 2,2-dimethoxy-2-phenylacetophenone, 2,2-diethoxyacetophenone, 1-hydroxycyclohexyl phenyl ketone, α-hydroxy-2-methylphenylpropanone, 1-hydroxy-1-methylethyl-(p-isopropylphenyl) ketone, 1-hydroxy-1-(p-dodecyl-phenyl) ketone, 2-methyl-(4′-(methylthio)phenyl)-2-morpholino-1-propanone, and 1,1,1-trichloromethyl-(p-butylphenyl) ketone; thioxanthone derivatives such as thioxanthone, 2-ethylthioxanthone, 2-isopropylthioxanthone, 2-chlorothioxanthone, 2,4-dimethylthioxanthone, 2,4-diethylthioxanthone, and 2,4-diisopropylthioxanthone; and benzoate ester derivatives such as ethyl p-dimethylaminobenzoate and ethyl p-diethylaminobenzoate.

As the above-described azo compounds, azo compounds as described in Japanese Patent Laid-Open No. 108621/1996 can be used.

Examples of the organic peroxide compounds include trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis-(tert-butylperoxy)butane, tert-butyl hydroperoxide, cumene hydroperoxide, diisopropylbeznene hydroperoxide, 2,5-dimethylhexane-2,5-dihydroperoxide, 1,1,3,3-tetra-methylbutyl hydroperoxide, tert-butylcumyl peroxide, dicumyl peroxide, 2,5-dimethyl-2,5-di(tert-butylperoxy)hexane, 2,5-oxanoyl peroxide, succinic peroxide, benzoyl peroxide, 2,4-dichlorobenzoyl peroxide, diisopropyl peroxydicarbonate, di-2-ethylhexyl peroxydicarbonate, di-2-ethoxyethyl peroxydicarbonate, dimethoxyisopropyl peroxycarbonate, di(3-methyl-3-methoxybutyl) peroxydicarbonate, tert-butyl peroxyacetate, tert-butyl peroxypivalate, tert-butyl peroxyneodecanoate, tert-butyl peroxyoctanoate, tert-butyl peroxylaurate, tertiary carbonate, 3,3′,4,4′-tetra-(t-butylperoxycarbonyl)benzophenone, 3,3′,4,4′-tetra-t-hexylperoxycarbonyl)benzophenone, 3,3′,4,4′-tetra-(p-isopropylcumylperoxycarbonyl)benzophenone, carbonyl di(t-butylperoxy dihydrogen diphthalate), and carbonyl di(t-hexylperoxy dihydrogen diphthalate).

Examples of the metallocene compounds include a variety of titanocene compounds as described in Japanese Patent Laid-Open Nos. 152396/1984, 151197/1986, 41484/1988, 249/1990, 4705/1990, and 83588/1993, for example, di-cyclopentadienyl-Ti-bisphenyl, di-cyclopentadienyl-Ti-bis-2,6-difluorophen-1-yl, di-cyclopentadienyl-Ti-bis-2,4-difluorophen-1-yl, di-clopentadienyl-Ti-bis-2,4,6-trifluorophen-1-yl, di-cyclopentadienyl-Ti-bis-2,3,5,6-tetrafluorophen-1-yl, di-cyclopentadienyl-Ti-bis-2,3,4,5,6-pentafluorophen-1-yl, di-methylcyclopentadienyl-Ti-bis-2,6-difluorophen-1-yl, di-methylcyclopentadienyl-Ti-bis-2,4,6-trifluorophen-1-yl, di-methylcyclopentadienyl-Ti-bis-2,3,5,6-tetrafluorophen-1-yl, and di-methylcyclopentadienyl-Ti-bis-2,3,4,5,6-pentafluorophen-1-yl; and iron-arene complexes as described in Japanese Patent Laid-Open Nos. 304453/1989 and 152109/1989.

Examples of the hexaaryl biimidazole compounds include a variety of compounds as described in Japanese Patent Publication No. 29285/1994 and U.S. Pat. Nos. 3,479,185, 4,311,783 and 4,622,286. Specific examples include 2,2′-bis(o-chlorophenyl)-4,4′,5,5′-tetraphenyl bimidazole, 2,2′-bis(o-bromophenyl)-4,4′,5,5′-tetraphenyl biimidazole, 2,2′-bis-(o,p-dichlorophenyl)-4,4′,5,5′-tetraphenyl biimidazole, 2,2′-bis(o-chlorophenyl)-4,4′,5,5′-tetra(m-methoxyphenyl) biimidazole, 2,2′-bis(o,o′-dichlorophenyl)-4,4′,5,5′-tetraphenyl biimidazole, 2,2′-bis(o-nitrophenyl)-4,4′,5,5′-tetraphenyl biimidazole, 2,2′-bis-(o-methylphenyl)-4,4′,5,5′-tetraphenyl biimidazole, and 2,2′-bis(o-trifluorophenyl)-4,4′,5,5′-tetraphenyl biimidazole.

Specific examples of the organic borate salt compounds include organic borate salts as described in Japanese Patent Laid-Open Nos. 143044/1987, 150242/1987, 188685/1997, 188686/1997, 188710/1997, 2000-131837, 2002-107916, Japanese Patent No. 2,764,769, Japanese Patent Laid-Open No. 2002-116539, Kunz, Martin, “Rad Tech '98. Proceeding Apr., 19-22(1998), Chicago”; organic boron sulfonium complexes or organic boron oxosulfonium complexes as described in Japanese Patent Laid-Open Nos. 157623/1994, 1755641/1994, and 175561/1994; organic boron iodonium complexes as described in Japanese Patent Laid-Open Nos. 175554/1994 and 175553/1994; organic boron phosphonium complexes as described in Japanese Patent Laid-Open No. 188710/1997; and organic boron transition metal-coordinated complexes as described in Japanese Patent Laid-Open Nos. 348011/1994, 128785/1995, 140589/1995, 306527/1995, and 292014/1995.

Examples of the disulfone compounds include compounds as described in Japanese Patent Laid-Open Nos. 166544/1986 and 2002-328465.

Examples of the oxime ester compound include compounds as described in J. C. S. Perkin II, 1653-1660(1979), J. C. S. Perkin II, 156-162(1979), Journal of Photopolymer Science and Technology 202-232(1995), and Japanese Patent Laid-Open Nos. 2000-66385 and 2000-80068. The following are specific examples of them.

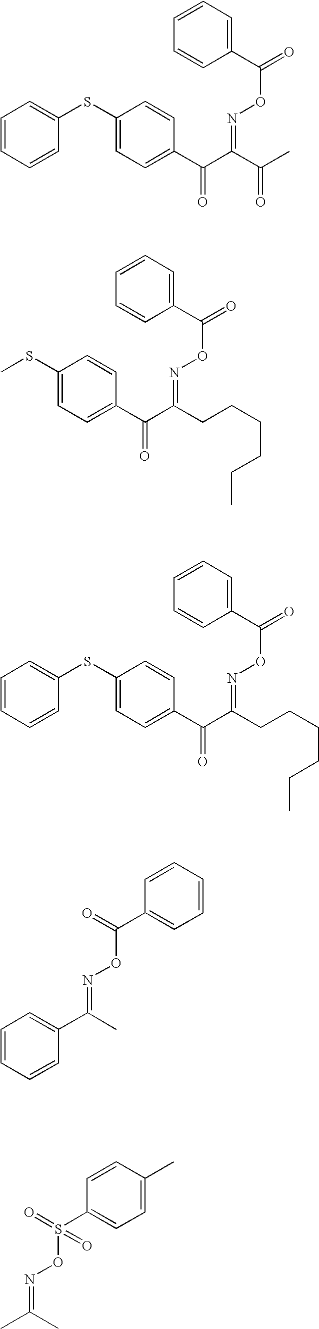

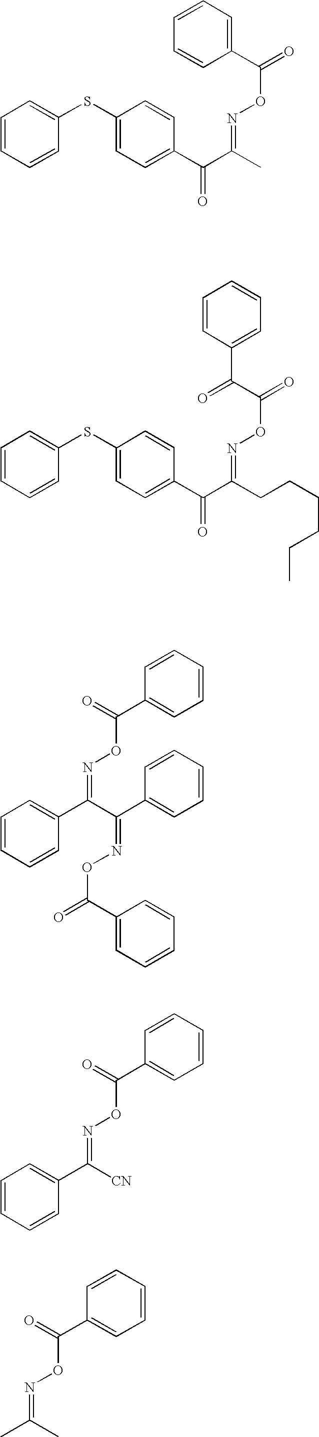

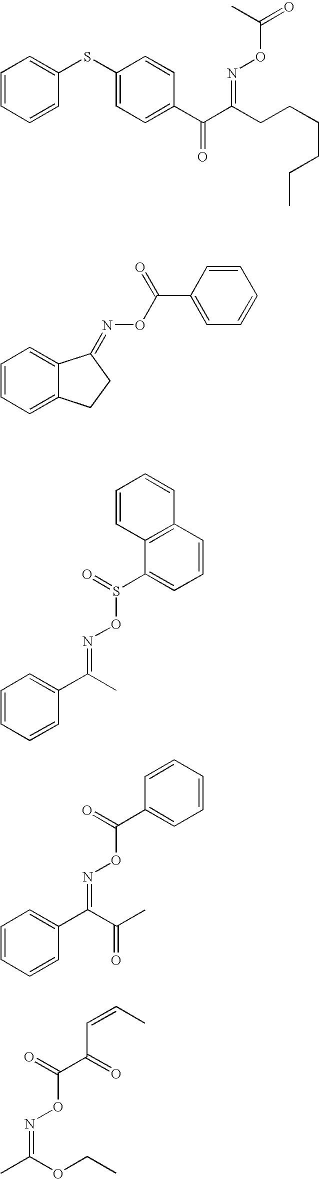

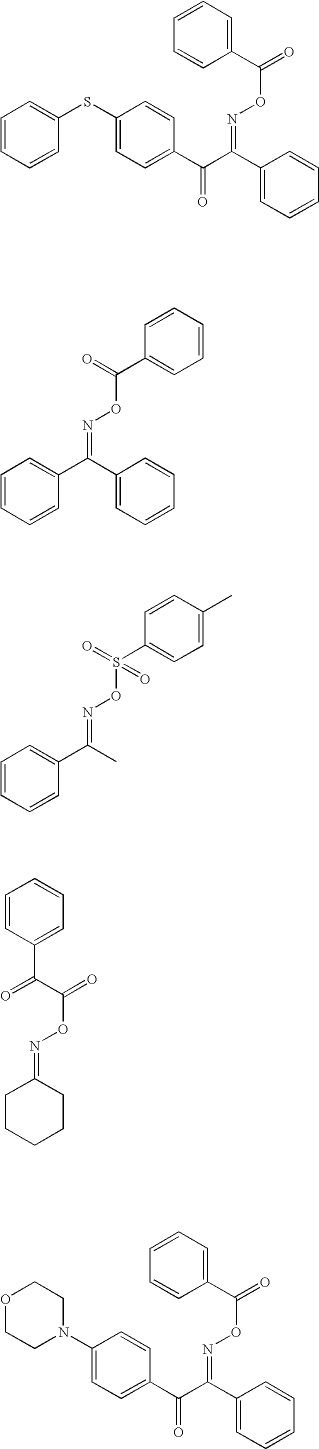

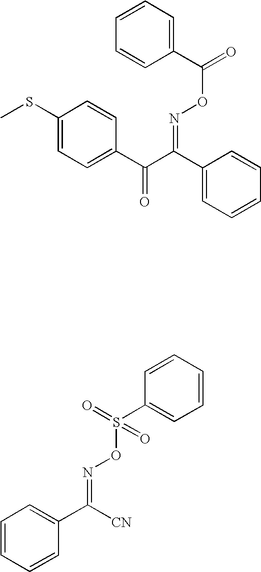

Specific examples of the onium salt include diazonium salts as described in S. I. Schlesinger, Photogr. Sci. Engr, 18, 387(1974) and T. S. Bal et al., Polymer, 21, 423(1980), ammonium salts as described in U.S. Pat. No. 4,069,055 and Japanese Patent Laid-Open No. 365049/1992, phosphonium salts as described in U.S. Pat. Nos. 4,069,055 and 4,069,056, iodonium salts as described in European Patent No. 104,143, U.S. Pat. Nos. 339,049 and 410,201, and Japanese Patent Laid-Open Nos. 150848/1990 and 296514/1990, sulfonium salts as described in European Patent Nos. 370,693, 390, 214, 233, 567, 297,443 and 297,442, U.S. Pat. Nos. 4,933,377, 161, 811, 410, 201, 339,049, 4,760,013, 4,734,444, and 2,833,827, German Patent Nos. 2,904,626, 3,604,580 and 3,604,581, selenonium salts as described in J. V. Crivello et al., Macromolecules, 10(6), 1307(1977), and J. V. Crivello et al., J. Polymer Sci., Polymer Chem. Ed., 17, 1047(1979), and arsonium salts as described in C. S. Wen et al., Teh. Proc. Conf. Rad. Curing ASIA, p. 478, Tokyo, Oct(1988).

Particularly from the viewpoints of reactivity and stability, the above-described oxime ester compounds, diazonium salts, iodonium salts and sulfonium salts can be given as examples. In the invention, these onium salts function not as an acid generator but as an ionic radical polymerization initiator.

The onium salts suited for use in the invention are the following onium salts of the formulas (RI-I) to (RI-III):

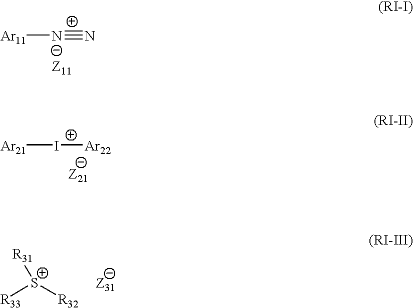

In the formula (RI-I), Ar₁₁ represents an aryl group which has 20 or less carbon atoms and may have 1 to 6 substituents. Preferred examples of the substituent include C₁₋₁₂ alkyl groups, C₁₋₁₂ alkenyl groups, C₁₋₁₂ alkynyl groups, C₁₋₁₂ aryl groups, C₁₋₁₂ alkoxy groups, C₁₋₁₂ aryloxy groups, halogen atoms, C₁₋₁₂ alklylamino groups, C₁₋₁₂ dialkylamino groups, C₁₋₁₂ alkylamide or arylamide groups, a carbonyl group, a carboxyl group, a cyano group, a sulfonyl group, C₁₋₁₂ thioalkyl groups, and C₁₋₁₂ thioaryl groups. Z₁₁⁻ represents a monovalent anion and examples of it include halogen ions, perchloric acid ions, hexafluorophosphate ions, tetrafluoroborate ions, sulfonic acid ions, sulfinic acid ions, thiosulfonic acid ions and sulfuric acid ions. From the viewpoint of stability, perchloric acid ions, hexafluorophosphate ions, tetrafluoroborate ions, sulfonic acid ions and sulfuric acid ions are preferred.

In the formula (RI-II), Ar₂₁ and Ar₂₂ each independently represents an aryl group which has 20 or less carbon atoms and may have 1 to 6 substituents. Preferred examples of the substituent include C₁₋₁₂ alkyl groups, C₁₋₁₂ alkenyl groups, C₁₋₁₂ alkynyl groups, C₁₋₁₂ aryl groups, C₁₋₁₂ alkoxy groups, C₁₋₁₂ aryloxy groups, halogen atoms, C₁₋₁₂ alkylamino groups, C₁₋₁₂ dialkylamino groups, C₁₋₁₂ alkylamide or arylamide groups, a carbonyl group, a carboxyl group, a cyano group, a sulfonyl group, C₁₋₁₂ thioalkyl groups, and C₁₋₁₂ thioaryl groups. Z₂₁⁻ represents a monovalent anion and examples of it include halogen ions, perchloric acid ions, hexafluorophosphate ions, tetrafluoroborate ions, sulfonic acid ions, sulfuric acid ions, thiosulfonic acid ions, sulfuric acid ions and carboxylic acid ions. From the viewpoints of stability and reactivity, perchloric acid ions, hexafluorophosphate ions, tetrafluoroborate ions, sulfonic acid ions, sulfinic acid ions and carboxylic acid ions are preferred.

In formula (RI-III), R₃₁, R₃₂ and R₃₃ each independently represents an aryl group which has 20 or less carbon atoms and may have 1 to 6 substituents, an alkyl group, an alkenyl group or an alkynyl group, of which the aryl groups are preferred from the viewpoint of reactivity and stability. Preferred examples of the substituent include C₁₋₁₂ alkyl groups, C₁₋₁₂ alkenyl groups, C₁₋₁₂ alkynyl groups, C₁₋₁₂ aryl groups, C₁₋₁₂ alkoxy groups, C₁₋₁₂ aryloxy groups, halogen atoms, C₁₋₁₂ alkylamino groups, C₁₋₁₂ dialkylamino groups, C₁₋₁₂ alkylamide or arylamide groups, a carbonyl group, a carboxyl group, a cyano group, a sulfonyl group, C₁₋₁₂ thioalkyl groups, and C₁₋₁₂ thioaryl groups. Z₃₁⁻ represents a monovalent anion and examples of it include halogen ions, perchloric acid ions, hexafluorophosphate ions, tetrafluoroborate ions, sulfonic acid ions, sulfinic acid ions, thiosulfonic acid ions, sulfuric acid ions and carboxylic acid ions. From the viewpoints of stability and reactivity, perchloric acid ions, hexafluorophosphate ions, tetrafluoroborate ions, sulfonic acid ions, sulfinic acid ions and carboxylic acid ions are preferred. Especially, carboxylic acid ions as described in Japanese Patent Laid-Open No. 2001-343742 are preferred, with carboxylic acid ions as described in Japanese Patent Laid-Open No. 2002-148790 being more preferred.

Specific examples of the polymerization initiator which can be used in the invention will be shown below, but examples are not limited thereto.

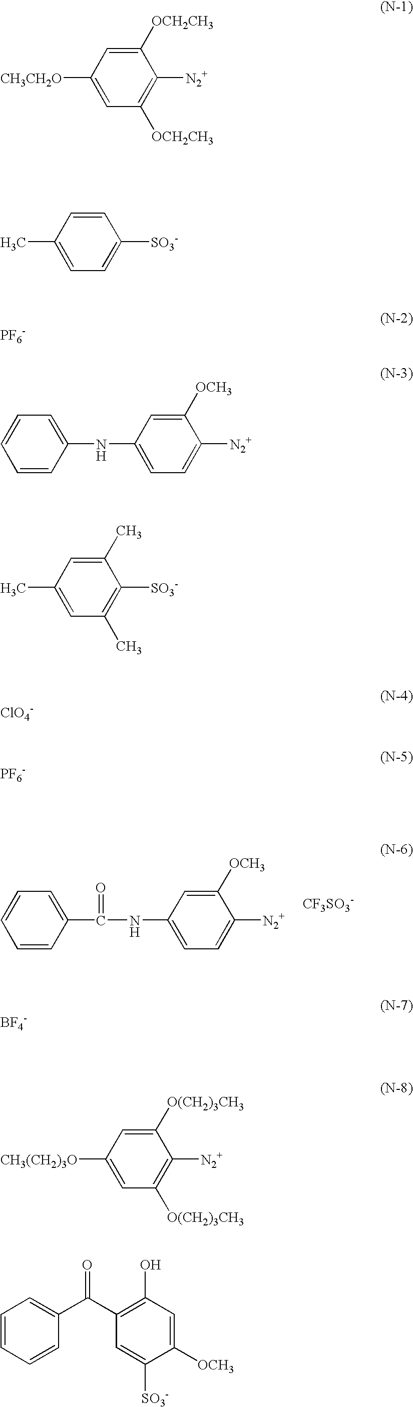

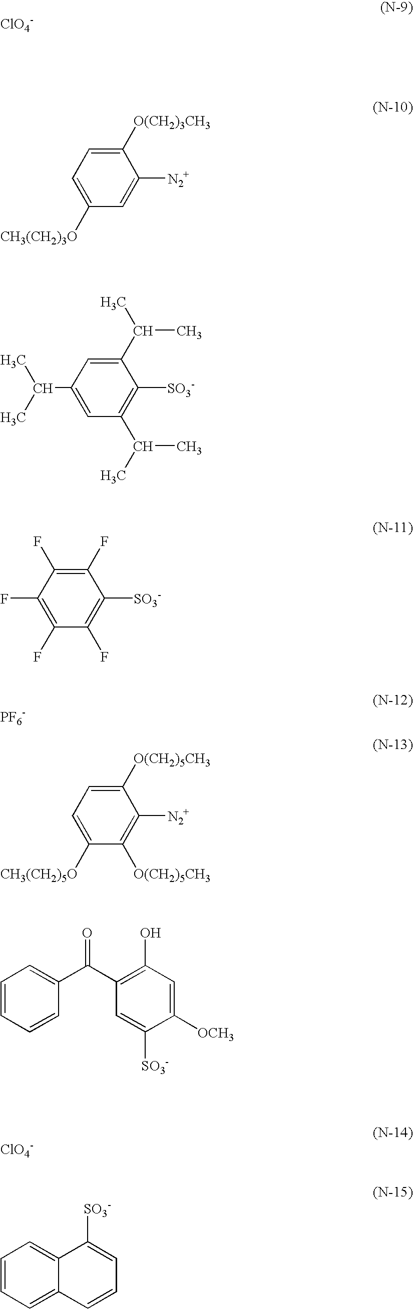

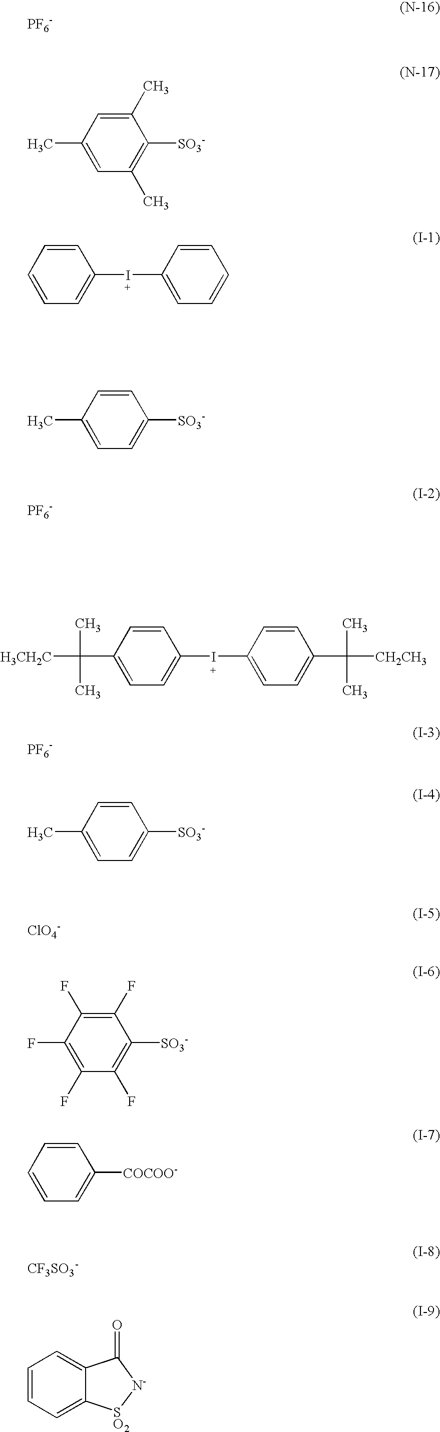

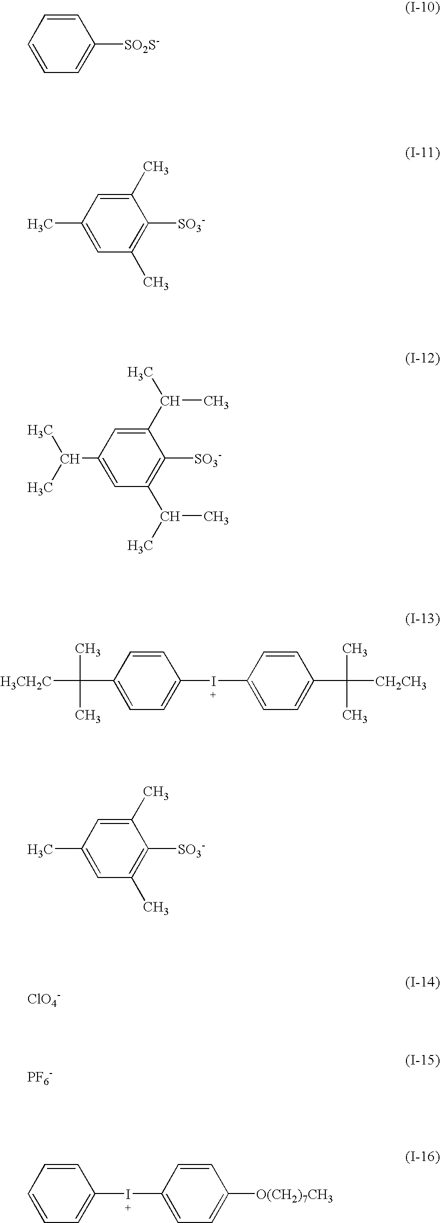

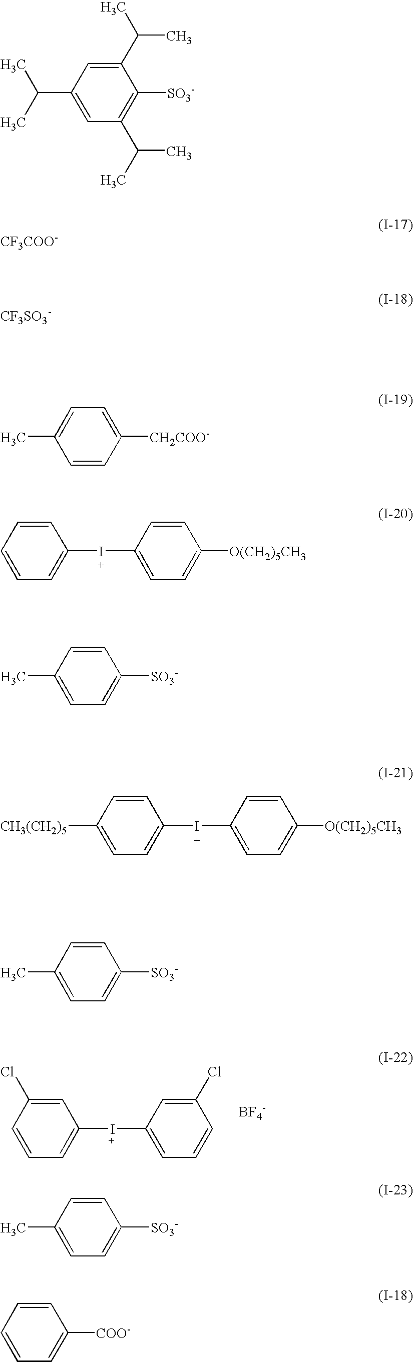

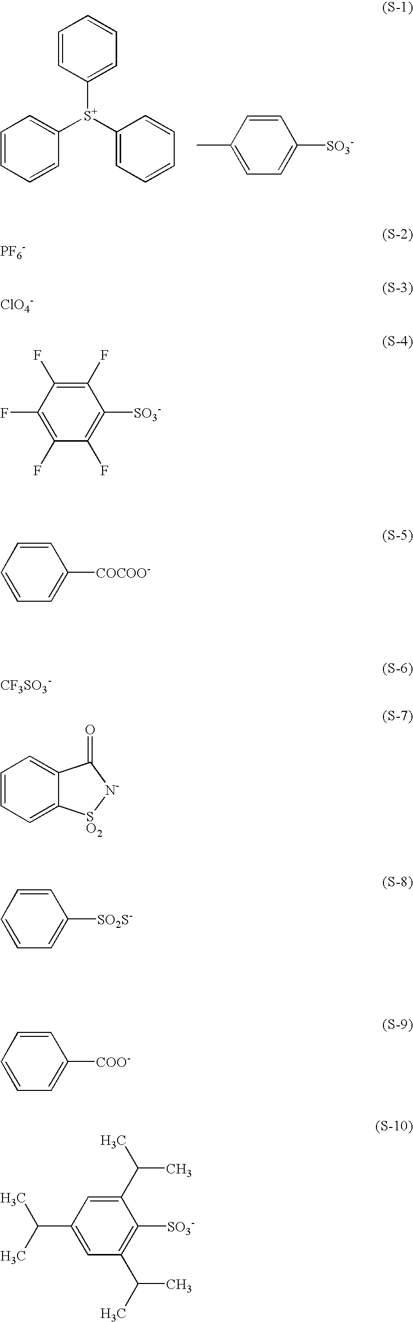

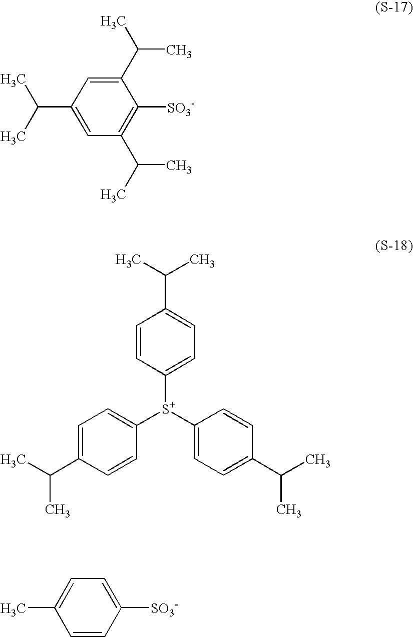

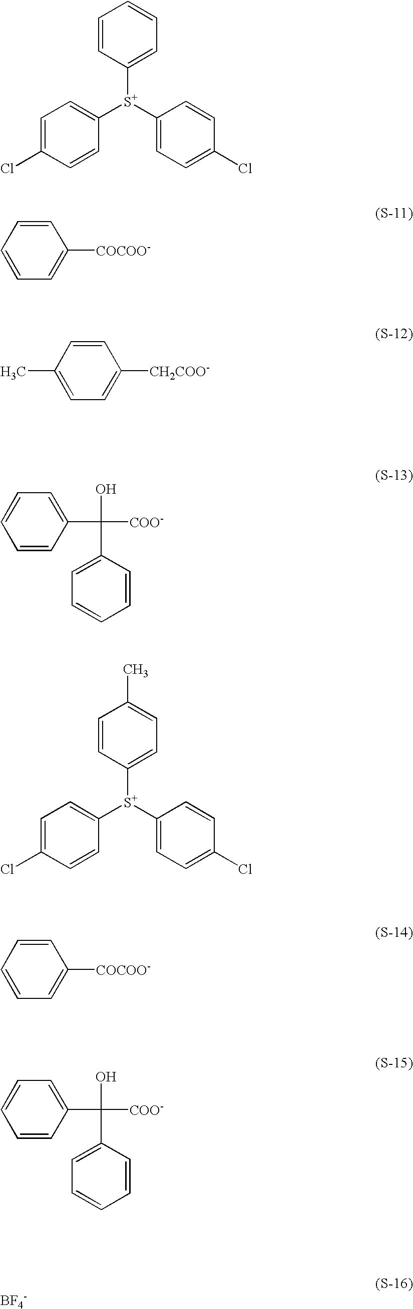

These polymerization initiators can be added in an amount of from 0.1 to 50 mass %, preferably from 0.5 to 30 wt. %, especially preferably from 1 to 20 mass % based on the whole solid content constituting the image recording layer. Within the above-descried range, good sensitivity and contamination resistance on a non-image area upon printing can be attained. These polymerization initiators may be used either singly or in combination. The polymerization initiator may be added to a layer containing the other components or may be added to another newly disposed layer.

(E) Polymerizable Compound

The polymerizable compound which can be used in the invention is an addition polymerizable compound having at least one ethylenically unsaturated double bond and is selected from compounds having at least one, preferably at least two terminal ethylenically unsaturated bonds. A group of such compounds is widely known in the industrial field related to the invention, and these compounds can be used in the invention without any particular limitation. These compounds are provided in the chemical form of, for example, a monomer or a prepolymer, that is, an oligomer including a dimer and a trimer, or a mixture or copolymer thereof. Examples of the monomer or copolymer thereof include unsaturated carboxylic acids (such as acrylic acid, methacrylic acid, itaconic acid, crotonic acid, isocrotonic acid, and maleic acid) and esters and amides thereof; preferably esters between an unsaturated carboxylic acid and an aliphatic polyol compound and amides between an unsaturated carboxylic acid and an aliphatic polyhydric amine compound. Also, addition reaction products of an unsaturated carboxylate ester or amide containing a nucleophilic substituent such as hydroxyl, amino or mercapto group with a monofunctional or polyfunctional isocyanate or an epoxy, and dehydration condensation reaction products of such unsaturated carboxylate ester or amide with a monofunctional or polyfunctional carboxylic acid are also suited for use. Also, addition reaction products of an unsaturated carboxylate ester or amide containing an electrophilic substituent such as isocyanate or epoxy group with a monofunctional or polyfunctional alcohol, amine or thiol, and substitution reaction products of an unsaturated carboxylate ester or amide containing an eliminative substituent such as halogen or tosyloxy group with a monofunctional or polyfunctional alcohol, amine or thiol are also suitable. Instead of the unsaturated carboxylic acid, a group of compounds in which the above-described unsaturated carboxylic acid is substituted by an unsaturated sulfonic acid, styrene or vinyl ether can also be used.

Specific examples of monomers of the ester of an aliphatic polyol compound and an unsaturated carboxylic acid will be given below. Examples of the acrylate esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomers and isocyanulic acid EO-modified triacrylate.

Examples of the methacrylate esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythiritol tetramethacrylate, dipentaerythritol dimethacrylate, dipentaerythritol hexamethacrylate, sorbitol trimethacrylate, sorbitol tetramethacrylate, bis-[p-(3-methacryloxy-2-hydroxypropoxy)phenyl]dimethylmethane, and bis[p-(methacryloxyethoxy)phenyl]dimethylmethane.

Examples of the itaconate esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate. Examples of the crotonate esters include ethylene glycol dicrotonate, tetramethylene glycol dicrotonate, pentaerythritol dicrotonate, and sorbitol tetradicrotonate. Examples of the isocrotonate esters include ethylene glycol diisocrotonate, pentaerythritol diisocrotonate, and sorbitol tetraisocrotonate. Examples of the maleate esters include ethylene glycol dimaleate, triethylene glycol dimaleate, pentaerythritol dimaleate, and sorbitol tetramaleate.

As the other examples of esters, aliphatic alcohol esters as described in Japanese Patent Publication No. 47334/1976, and Japanese Patent Laid-Open No. 196231/1982; esters having an aromatic skeleton as described in Japanese Patent Laid-Open Nos. 5240/1984, 5241/1984, and 226149/1990; and esters containing an amino group as described in Japanese Patent Laid-Open No. 165613/1989 are suited for use. Further, the above-described ester monomers can be used as a mixture.

Examples of monomers of the amide between an aliphatic polyhydric amine compound and an unsaturated carboxylic acid include methylenebis-acrylamide, methylenebis-methacrylamide, 1,6-hexamethylenebis-acrylamide, 1,6-hexamethylenebis-methacrylamide, diethylenetriamine trisacrylamide, xylylenebisacrylamide, and xylylenebismethacrylamide. As the other preferred examples of amide monomers, those having a cyclohexylene structure as described in Japanese Patent Publication No. 21726/1979 can be given.

Urethane addition polymerizable compounds prepared utilizing addition reaction between an isocyanate and a hydroxyl group are also suitable. Specific examples include vinyl urethane compounds, as described in Japanese Patent Publication No. 41708/1973, having, in one molecule thereof, two or more polymerizable vinyl groups and prepared by adding a hydroxyl-containing vinyl monomer represented by the below-described formula (II) to a polyisocyanate compound having, in one molecule thereof, at least two isocyanate groups.
CH₂═C(R₄)COOCH₂CH(R₅)OH (II)
wherein, R₄ and R₅ each represents H or CH₃.

Urethane acrylates as described in Japanese Patent Laid-Open No. 37193/1976 and Japanese Patent Publication Nos. 32293/1990 and 16765/1990; and urethane compounds having an ethylene oxide skeleton as described in Japanese Patent Publication No. 49860/1983, 17654/1981, 39417/1987, and 39418/1987 are suitable. Further, by using an addition polymerizable compound having, in the molecule thereof, an amino structure or a sulfide structure, as described in Japanese Patent Laid-Open Nos. 277653/1988, 260909/1988, and 105238/1989, it is possible to obtain a photopolymerizable composition having very excellent photosensitive speed.

Other examples include polyester acrylates and polyfunctional acrylates or methacrylates such as epoxy acrylates obtained by reacting an epoxy resin and (meth)acrylic acid, as described in Japanese Patent Laid-Open No. 64183/1973, Japanese Patent Publication Nos. 43191/1974 and 30490/1977. Also, specific unsaturated compounds as described in Japanese Patent Publication Nos. 43946/1971, 40337/1989, and 40336/1989; and vinyl phosphonic acid compounds as described in Japanese Patent Laid-Open No. 25493/1990 can be mentioned as examples. Also, in some cases, compounds having a perfluoroalkyl-containing structure as described in Japanese Patent Laid-Open No. 22048/1986 are suitably used. Further, compounds introduced as a photocurable monomer or oligomer in Journal of The Adhesion Society of Japan, Vol. 20, No. 7, pp. 300-308(1984) can be used.

With regards to these polymerizable compounds, the details of their structures and the using method including, single use or combined use, and addition amount can be set up as desired depending upon the ultimate performance design of a lithographic printing plate precursor. For example, it is selected from the following viewpoints.

From the viewpoint of the sensitivity, a structure having a high content of an unsaturated group per molecule is preferred, and in many cases, compounds having at least two functionalities are preferred. For the sake of enhancing the strength in an image area, that is, a cured film, compounds having at least three functionalities are preferred. Further, a method of adjusting both the sensitivity and strength by using compounds different in functionality and different in polymerizable group (such as acrylate ester, methacrylate ester, styrene compound, and vinyl ether compound) is effective.

Also, with respect to compatibility with or dispersibility in other components (such as a binder polymer, an initiator, and a coloring agent) in the image recording layer, selection and using methods of addition polymerizable compounds are important factors. For example, the compatibility may possibly be enhanced by using a low-purity compound or combined use of two or more of the compounds. It is also possible to select a compound having a specific structure in order to improve adhesion with a substrate or an overcoat layer which will be described later.

The polymerizable compound is added preferably in an amount ranging from 5 to 80 mass %, more preferably from 25 to 75 mass % based on the non-volatile components in the image recording layer. The polymerizable compounds may be used singly or in combination of two or more thereof. Besides, concerning the using method of the addition polymerizable compound, an appropriate structure, mixing and addition amount can be selected as desired from the viewpoints of degree of polymerization inhibition against oxygen, resolution, fogging properties, change in refractive index, and surface adhesion. Further, in some cases, the polymerizable compound can be used in consideration of a layer constitution or coating method such as undercoating and overcoating.

In the invention, some modes can be employed as a method of incorporating, in the image recording layer, the above-described components (A) to (E) constituting the image recording layer and the other components which will be descried later. One of them is a molecule-dispersion type image recording layer as described, for example, in Japanese Patent Laid-Open No. 2002-287334 obtained by dissolving the components in a proper solvent and then applying the resulting solution. Another mode is a microcapsule type image recording layer as described, for example, in Japanese Patent Laid-Open No. 2001-277740 or 2001-277742 in which all or some of the components microencapsulated in a microcapsule are incorporated. In the microcapsule type image recording layer, the components may be incorporated outside the microcapsule. In a preferred mode, hydrophobic components are encapsulated in a microcapsule, while hydrophilic components are incorporated outside the capsule. The image recording layer is preferably a microcapsule type image recording layer in order to attain better on-press developabiliy.

Known methods can be employed for microencapsulating the above-described components (A) to (E) constituting the image recording layer. Examples include the method utilizing coacervation as disclosed in U.S. Pat. Nos. 2,800,457 and 2,800,458; the method utilizing interface polymerization as disclosed in U.S. Pat. No. 3,287,154 and Japanese Patent Publication Nos. 19574/1963 and 446/1967; the method utilizing precipitation of a polymer as disclosed in U.S. Pat. Nos. 3,418,250 and 3,660,304; the method utilizing an isocyanate polyol wall material as disclosed in U.S. Pat. No. 3,796,669; the method using an isocyanate wall material as disclosed in U.S. Pat. No. 3,914,511; the method using a urea-formaldehyde or urea formaldehyde-resorcinol wall forming material as disclosed in U.S. Pat. Nos. 4,001,140, 4,087,376 and 4089802; the method using wall materials such as melanine-formaldehyde resin or hydroxycellulose as disclosed in U.S. Pat. No. 4,025,445; the in situ method using polymerization of a monomer as disclosed in Japanese Patent Publication Nos. 9163/1961 and 9079/1976; the spray drying method as disclosed in GB Patent No. 930422 and U.S. Pat. No. 3,111,407; and the electrolytic dispersion cooling method as disclosed in GB Patent Nos. 952807 and 967074.

The microcapsule wall preferably used in the invention has a three-dimensional crosslink and swells with a solvent. From such a viewpoint, polyurea, polyurethane, polyester, polycarbonate and polyamide, and mixtures thereof are preferred as a wall material for microcapsules, of which polyurea and polyurethane are especially preferred. A compound having a crosslinkable functional group such as ethylenically unsaturated bond which can be introduced into the organic polymer serving as the above-described non-water-soluble binder (A) may be introduced into the microcapsule wall.

The microcapsule has preferably an average particle size of from 0.01 to 3.0 μm, more preferably from 0.05 to 2.0 μm, especially preferably from 0.10 to 1.0 μm. With this range, good resolution and stability over time can be attained.

Image Recording Layer (2)

The image recording layer (2) contains at least a binder and particles, wherein the particles are microcapsules having a polymerizable functional group as a wall material and the binder is a polymer binder.

It is preferred that the image recording layer (2) further contains an infrared absorber, polymerization initiator and polymerizable compound.

Infrared absorbers, polymerization initiators and polymerizable compounds similar to those listed in the image recording layer (1) can be used as the infrared absorber, polymerization initiator and polymerizable compound of the image recording layer (2), respectively.

(F) Polymer Binder

As the polymer binder which can be used for the image recording layer (2), conventionally known ones can be used without limitation. Polymers having film forming properties are preferred. Examples of such a polymer binder include acrylic resins, polyvinyl acetal resins, polyurethane resins, polyurea resins, polyimide resins, polyamide resins, epoxy resins, methacrylic resins, polystyrene resins, novolac-type phenolic resins, polyester resins, synthetic rubbers and natural rubbers.

The polymer binder may have crosslinkability in order to improve the film strength of an image area. To impart the binder with crosslinkability, a crosslinkable functional group such as ethylenically unsaturated bond may be introduced into the polymer main chain or side chain. The crosslinkable functional group may be introduced by copolymerization.

Examples of the polymer having an ethylenically unsaturated bond in the main chain of the molecule include poly-1,4-butadiene and poly-1,4-isoprene.

Examples of the polymer having an ethylenically unsaturated bond in the side chain of the molecule include polymers of an acrylate or methacrylate ester or amide, in which the ester or amide residue (the “R” in —COOR or —CONHR) has an ethylenically unsaturated bond.

Examples of the residue (the above-described “R”) having an ethylenically unsaturated bond include —(CH₂)ₙCR₁═CR₂R₃, —(CH₂O)ₙCH₂CR₁═CR₂R₃, —CH₂CH₂O)ₙCH₂CR₁═CR₂R₃, —(CH₂)ₙNH—CO—O—CH₂CR₁═CR₂R₃, —(CH₂)ₙ—O—CO—CR₁═CR₂R₃ and —(CH₂CH₂O)₂—X (wherein R₁ to R₃ each represents a hydrogen atom, a halogen atom, or a C₁₋₂₀ alkyl, aryl, alkoxy or aryloxy group, and R₁ may be coupled with R₂ or R₃ to form a ring; n stands for an integer from 1 to 10; and X represents a dicyclopentadienyl residue).

Specific examples of the ester residue include —CH₂CH═CH₂ (as described in Japanese Patent Publication No. 21633/1995), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples of the amide residue include —CH₂CH═CH₂, —CH₂CH₂—Y (wherein Y represents a cyclohexene residue) and —CH₂CH₂—OCO—CH═CH₂.

The polymer binder having crosslinkability is cured, for example, in the following manner. Free radicals (polymerization initiating radicals, or propagation radicals during polymerization of the polymerizable compound) are added to the crosslinkable functional groups of the binder and polymers undergo addition polymerization either directly or via polymerized chains of the polymerizable compound, resulting in the formation of crosslinks between the polymer particles. Alternatively, atoms in the polymer (for example, hydrogen atoms on the carbon atoms adjacent to the crosslinkable functional groups) are drawn out by free radicals to form polymer radicals and they bond to each other to form crosslinks between the polymer molecules.

The content of the crosslinkable groups in the polymer binder (content of radical-polymerizable unsaturated double bonds, as determined by iodine titration) is preferably from 0.1 to 10.0 mmol more preferably from 1.0 to 7.0 mmol, most preferably from 2.0 to 5.5 mmol, per gram of the polymer binder. Within this range, good sensitivity and good storage stability can be attained.

From the viewpoint of the on-press developability of an unexposed area of an image recording layer, the polymer binder has preferably high solubility or dispersibility in an ink and/or fountain solution.

In order to heighten the solubility or dispersibility in ink, it is preferably lipophilic, while in order to heighten the solubility or dispersibility in fountain solution, it is preferably hydrophilic. In the invention, therefore it is effective to use a lipophilic polymer binder and a hydrophilic polymer binder in combination.

Preferred example of the hydrophilic polymer include those having a hydrophilic group such as hydroxy, carboxyl, carboxylate, hydroxyethyl, polyoxyethyl, hydroxypropyl, polyoxypropyl, amino, aminoethyl, aminopropyl, ammonium, amide, carboxymethyl, sulfonic acid or phosphoric acid group.

Specific examples of such binders include gum arabic, casein, gelatin, starch derivatives, carboxymethyl cellulose and sodium salt thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a degree of hydrolysis of at least 60 wt %, preferably at least 80 wt %, polyvinyl formal, polyvinyl butyral, polyvinylpyrrolidone, homopolymers and copolymers of acrylamides, homopolymers and copolymers of methacrylamides, homopolymers and copolymers of N-methylolacrylamide, alcohol-soluble nylon, and polyether of 2,2-bis-(4-hydroxyphenyl)propane and epichlorohydrin.

The polymer binder (F) has preferably a weight-average molecular weight of 5,000 or greater, more preferably from 10,000 to 300,000, and has preferably a number-average molecular weight of 1,000 or greater, more preferably from 2,000 to 250,000. The polydispersity (weight-average molecular weight/number-average molecular weight) is preferably from 1.1 to 10.

The polymer (F) can be synthesized by the conventionally known method. Examples of the solvent to be used upon synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethyl sulfoxide and water. They may be used either singly or as a mixture of two or more thereof.

Radical polymerization initiators used upon synthesis of the polymer binder (F) include known compounds such as azo initiators and peroxide initiators.

The content of the polymer binder (F) ranges from 5 to 90 mass %, preferably from 5 to 80 mass %, based on the total solid content in the image recording layer. Within this range, the strength of the image area and image forming properties are good.

It is preferred to use the polymerizable compound (E) and the polymer binder (F) to give a mass ratio of from 0.5/1 to 4/1.

(G) Microcapsule Having Polymerizable Functional Group In Wall Material Thereof

In the image recording layer (2), a microcapsule having, encapsulated therein, a portion of the above-described components (C) to (F) constituting the image recording layer and the other components which will be described layer is added to an image forming layer as described, for example, in Japanese Patent Laid-Open Nos. 2001-277740 and 2001-277742. In the microcapsule-type image recording layer, these components can be incorporated in or out of the microcapsule at a desired ratio.

Known methods can be employed for microencapsulating the above-described components (C) to (F) constituting the image recording layer. Examples include the method utilizing coacervation as disclosed in U.S. Pat. Nos. 2,800,457 and 2,800,458; the method utilizing interface polymerization as disclosed in U.S. Pat. No. 3,287,154, and Japanese Patent Publication Nos. 19574/1963 and 446/1967; the method utilizing precipitation of a polymer as disclosed in U.S. Pat. Nos. 3,418,250 and 3,660,304; the method utilizing an isocyanate polyol wall material as disclosed in U.S. Pat. No. 3,796,669; the method using an isocyanate wall material as disclosed in U.S. Pat. No. 3,914,511; the method using a urea-formaldehyde or urea formaldelyde-resorcinol wall forming material as disclosed in U.S. Pat. Nos. 4,001,140, 4,087,376 and 4089802; the method using wall materials such as melamine-formaldehyde resin or hydroxycellulose as disclosed in U.S. Pat. No. 4,025,445; the in situ method using polymerization of a monomer as disclosed in Japanese Patent Publication Nos. 9163/1961 and 9079/1976; the spray drying method as disclosed in GB Patent No. 930422 and U.S. Pat. No. 3,111,407; and electrolytic dispersion cooling method as disclosed in GB Patent Nos. 952807 and 967074.

The microcapsule wall preferably used in the invention has a three-dimensional crosslink and swells with a solvent. From such a viewpoint, polyurea, polyurethane, polyester, polycarbonate and polyamide, and mixtures thereof are preferred as a wall material for microcapsules, of which polyurea and polyurethane are especially preferred. A functional group having an ethylenically unsaturated bond as described below must be introduced into the wall of the microcapsule.

Examples of the partial structure having a functional group with an ethylenically unsaturated bond include, but not limited to, —(CH₂)ₙCR₁═CR₂R₃, —(CH₂O)ₙCH₂CR₁═CR₂R₃, —(CH₂CH₂O)ₙCH₂CR₁═CR₂R₃, —(CH₂)ₙNNH—CO—O—CH₂CR₁═CR₂R₃, —(CH₂)ₙ—O—CO—CR₁═CR₂R₃ and —(CH₂CH₂O)₂—X (wherein R₁ to R₃ each represents a hydrogen atom, a halogen atom, or a C₁₋₂₀ alkyl, aryl, alkoxy or aryloxy group, and R₁ may be coupled with R₂ or R₃ to form a ring; n stands for an integer from 1 to 10; and X represents a dicyclopentadienyl residue).

The ethylenically unsaturated bond preferably exists on the surface portion of the microcapsule. Accordingly, the ethylenically unsaturated bond is preferably incorporated in the side chain portion rather than in the main chain portion of a shell polymer forming the wall.

As the main chain of the shell polymer, a condensation polymerization type polymer is preferable to an addition polymerization type polymer. More specifically, polyurethane, polyurea, polyester or polyamide, or copolymer or mixture thereof is preferred, with polyurethane or polyurea, or a copolymer or mixture thereof being more preferred.

Polyurethane is a polymer containing a urethane bond (—NH—CO—O—) in its main chain, polyurea is a polymer containing a urea bond (—NH—CO—NH—) in its main chain, polyester is a polymer containing an ester bond (—CO—O—) in its main chain, and polyamide is a polymer containing an amide bond (—CO—NH—) in its main chain. The copolymer is a polymer containing at least two bonds in its main chain.

The polyurethane or polyurea, or copolymer thereof can be synthesized by the reaction between a polyol or polyamine and polyisocyanate. Alternatively, it can be synthesized by the condensation reaction between a polyamine generated by the hydrolysis of a polyisocyanate and a polyisocyanate. In the synthesizing reaction of a shell polymer for microcapsules, the shell polymer is preferably synthesized by synthesizing, as an intermediate, an adduct obtained by reacting a polyisocyanate with a polyol, and then reacting the adduct. In the practical reaction, an excessive amount of a polyisocyanate relative to a polyol tends to be added to the reaction system. In addition to the polyol, a nucleophilic compound (such as alcohol, phenol, thiol or amine) having a nucleophilic group (such as hydroxyl, mercapto or amino) is sometimes reacted with a polyisocyanate. In some cases, a shell polymer is synthesized after reacting a nucleophilic compound with an adduct of a polyol and a polyisocyanate, thereby modifying a portion of the adduct. The alcohol may be a polymer having, at the terminal thereof, a hydroxyl group (a high molecular compound having a lactone ring and a hydroxyl group when an ethylenic double bond is introduced).

In the invention, it is most preferred to synthesize a shell polymer by introducing an ethylenic double bond into not a polyisocyanate but a polyol or a nucleophilic compound to be used together with a polyol, reacting the resulting compound with the polyisocyanate to synthesize the corresponding isocyanate adduct, and then reacting the adduct.

The ethylenic-double-bond-containing compound to be used for the synthesis of the shell polymer is preferably represented by the following formula (III):
L₁LcₘZₙ

In the formula (III), L₁ is a linking group having a valency of m+n; m and n each independently stands for an integer of from 1 to 100; Lc is a monovalent group made of an ethylenic double bond; and Z is a nucleophilic group.

L₁ is preferably an aliphatic group having at least two valences, an aromatic group having at least two valences, a heterocyclic group having at least two valences, —O—, —S—, —NH—, —N<, —CO—, —SO— or —SO₂—, or combination thereof.

It is preferred that the letters m and n each independently stands for an integer of from 1 to 50, more preferably an integer of from 1 to 20, still more preferably an integer of from 1 to 10, most preferably an integer of from 1 to 5.

Z is preferably OH, SH or NH₂, with OH or NH₂ being more preferred and OH being most preferred.

The followings are examples of the ethylenic-double-bond-containing compound, but it is not limited to these structures.

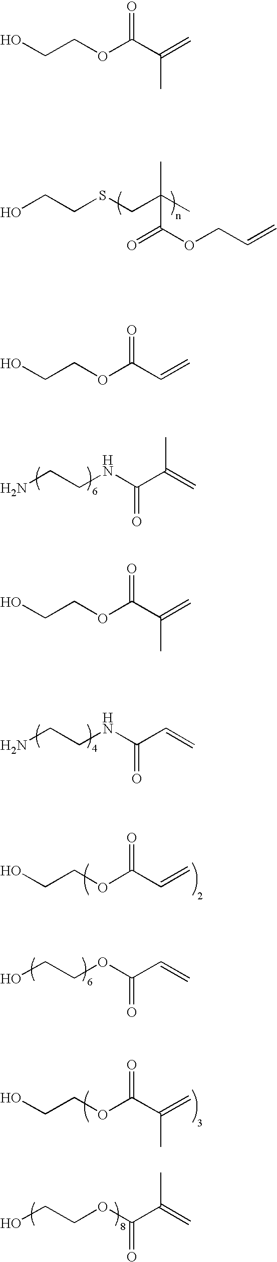

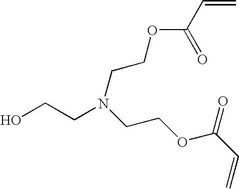

Two or more of these ethylenic-double-bond-containing compounds may be used in combination.

The ethylenic-double-bond-containing compound and another polyol may be used in combination for the formation of an adduct with a polyisocyanate. Alternatively, an adduct of an ethylenic-double-bond-containing compound and a polyisocyanate can be used in combination with an adduct of another polyol and a polyisocyanate. An adduct of another polyol and a polyisocyanate may be reacted with an ethylenic-double-bond-containing compound to synthesize an ethylenic-double-bond-containing adduct (to modify the adduct).

In addition to the ethylenic-double-bond-containing compound or polyol, a polyamine may be used for the formation of a shell polymer. The polyamine is preferably water soluble. Examples of the polyamine include ethylenediamine, propylenediamine, phenylenediamine, diethylenetriamine, triethylenetetramine and tetraethylenepentamine.

The polyisocyanate is preferably a diisocyanate represented by the following formula (IV).
OCN-L₄-NCO(IV)

In the formula (IV), L₄ is a divalent linking group. The group L₄ is preferably a divalent group selected from the class consisting of alkylene groups, substituted alkylene groups, arylene groups and substituted arylene groups, and combinations thereof. The divalent linking groups having an alkylene group and an arylene group in combination are particularly preferred.

The alkylene group may have a cyclic or branched structure. The alkylene group has preferably 1 to 20 carbon atoms, more preferably 1 to 15 carbon atoms, more preferably 1 to 10 carbon atoms, most preferably 1 to 8 carbon atoms.

Examples of the substituent of the substituted alkylene or alkyl group include halogen atoms, oxo (═O), thio (═S), aryl groups, substituted aryl groups and alkoxy groups.

The arylene group is preferably phenylene, most preferably p-phenylene.

Examples of the substituent of the substituted arylene or aryl group include halogen atoms, alkyl groups, substituted alkyl groups, aryl groups, substituted aryl groups and alkoxy groups.

Examples of the diisocyanate include xylylene diisocyanates (such as m-xylylene diisocyanate and p-xylylene diisocyanate), 4-chloro-m-xylylene diisocyanate, 2-methyl-m-xylylene diisocyanate, phenylene diisocyanates (such as m-phenylene diisocyanate and p-phenylene diisocyanate), toluylene diisocyanates (such as 2,6-toluylene diisocyanate and 2,4-toluylene diisocyanate), naphthalene diisocyanates (such as naphthalene 1,4-diisocyanate), isophorone diisocyanate, alkylene diisocyanates (such as trimethylene diisocyanate, hexamethylene diisocyanate, propylene 1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-1,4-diisocyanate, 1,4-bis(isocyanatomethyl)cyclohexane, 1,3-bis(isocyanatomethyl)cyclohexane), diphenylmethane-4,4′-diisocyanate, 3,3′-dimethoxybiphenyl diisocyanate, 3,3′-dimethyldiphenylmethane-4,4′-diisocyanate, 4,4′-diphenylpropane diisocyanate, 4,4′-diphenylhexafluoropropane diisocyanate and lysine diisocyanate.

Of these, xylylene diisocyanate and toluylene-diisocyanate are preferred, with xylylene diisocyanate being more preferred, and m-xylylene diisocyanate being most preferred.

Two or more of these diisocyanates may be used in combination.

As described above, the shell polymer is preferably prepared by reacting a polyol with a polyisocyanate to synthesize an adduct as an intermediate (or prepolymer), and then reacting the adduct.

In the synthesizing reaction of the adduct, the mass ratio of polyol/polyisocyanate preferably falls within a range of from 1/100 to 80/100, more preferably from 5/100 to 50/100.

The polyol and the polyisocyanate can be reacted by heating them in an organic solvent. In the absence of a catalyst, heating temperature is preferably from 50° C. to 100° C. In the presence of a catalyst, on the other hand, the reaction proceeds at a relatively low temperature (from 40 to 70° C.). Examples of the catalyst include stannous octylate and dibutyltin diacetate.

The organic solvent is preferably an active-hydrogen-free liquid (in other words, an alcohol, phenol and amine are not preferred). Examples of the organic solvent include esters (e.g., ethyl acetate), halogenated hydrocarbons (e.g., chloroform), ethers (e.g., tetrahydrofuran), ketones (e.g., acetone), nitrites (e.g., acetonitrile) and hydrocarbons (e.g., toluene).

The microcapsule has preferably an average particle size of from 0.01 to 3.0 μm, more preferably from 0.05 to 2.0 μm, especially preferably from 0.10 to 1.0 μm. Within this range, good resolution and stability over time can be attained.

Other Components to be Added to the Image Recording Layer (1) or (2)

Surfactant

In the invention, it is preferred to add a surfactant to the image recording layer in order to promote its on-machine developability upon initiation of printing and improve the state of the coated surface. Examples of the surfactant include nonionic surfactants, anionic surfactants, cationic surfactants, amphoteric surfactants and fluorosurfactants. These surfactants may be used either singly or in combination of two or more of them.

Any conventionally known nonionic surfactant may be used in the invention without particular limitation. Examples include polyoxyethylene alkyl ethers, polyoxyethylene alkylphenyl ethers, polyoxyethylene polystyrylphenyl ethers, polyoxyethylene polyoxypropylene alkyl ethers, partial fatty acid esters of glycerol, partial fatty acid esters of sorbitan, partial fatty acid esters of pentaerythritol, fatty acid monoesters of propylene glycol, partial fatty acid esters of sucrose, partial fatty acid esters of polyoxyethylene sorbitan, partial fatty acid esters of polyoxyethylene sorbitol, fatty acid esters of polyethylene glycol, partial fatty acid esters of polyglycerol, polyoxyethylenated castor oils, partial fatty acid esters of polyoxyethylene glycerol, fatty acid diethanolamides, N,N-bis-2-hydroxyalkylamines, polyoxyethylene alkyl amines, fatty acid esters of triethanolamine, trialkylamine oxides, polyethylene glycol, and copolymers of polyethylene glycol and polypropylene glycol.

Any conventionally known anionic surfactant may be used in the invention without particular limitation. Examples include fatty acid salts, abietates, hydroxyalkanesulfonates, alkanesulfonates, dialkylsulfosuccinates, linear alkylbenzenesulfonates, branched alkylbenzenesulfonates, alkylnaphthalenesulfonates, alkylphenoxypolyoxyethylene propylsulfonates, polyoxyethylene alkylsulfophenyl ether salts, sodium salt of N-methyl-N-oleyltaurine, disodium salts of N-alkylsulfosuccinic monoamides, petroleum sulfonates, sulfated tallow oil, sulfates of fatty acid alkyl esters, alkyl sulfates, polyoxyethylene alkyl ether sulfatess, fatty acid monoglyceride sulfates, polyoxyethylene alkylphenyl ether sulfates, polyoxyethylene styrylphenyl ether sulfates, alkyl phosphates, polyoxyethylene alkyl ether phosphates, polyoxyethylene alkylphenyl ether phosphates, partially saponified styrene/maleic anhydride copolymers, partially saponified olefin/maleic anhydride copolymers and naphthalenesulfonate-formalin condensates.

Any conventionally known cationic surfactant may be used in the invention without particular limitation. Examples include alkylamine salts, quaternary ammonium salts, polyoxyethylene alkylamine salts and polyethylene polyamine derivatives.

Any conventionally known amphoteric surfactant may be used in the invention without particular limitation. Examples include carboxybetaines, aminocarboxylic acids, sulfobetaines, aminosulfate esters and imidazolines.

In the above-described surfactants, the term “polyoxyethylene” may be substituted with the term “polyoxyalkylene” such as polyoxymethylene, polyoxypropylene and polyoxybutylene. These surfactants can also be used in the invention.

Fluorosurfactants having, in the molecule thereof, a perfluoroalkyl group are preferable surfactants. Examples of such fluorosurfactants include anionic type such as perfluoroalkylcarboxylates, perfluoroalkylsulfonates and perfluoroalkylphosphate esters; amphoteric type such as perfluoroalkylbetains; cationic type such as perfluoroalkyltrimethylammonium salts; and nonionic type such as perfluoroalkylamine oxides, perfluoroalkylethylene oxide adducts, oligomers containing a perfluoroalkyl group and a hydroplilic group, oligomers containing a perfluoroalkyl group and a lipophilic group, oligomers containing a perfluoroalkyl group, a hydrophilic group and a lipophilic group, and urethanes containing a perfluoroalkyl group and a lipophilic group. Preferred examples include the fluorosurfactants as described in Japanese Patent Laid-Open Nos. 170950/1987, 226143/1987 and 168144/1985.

These surfactants may be used either singly or in combination of two or more thereof.

The content of the surfactant preferably ranges from 0.001 to 10 mass/, more preferably from 0.01 to 5 mass %, based on the total solid content in the image recording layer.

Colorant

In the invention, various other compounds may also be added if necessary. For example, a dye having a large absorption in the visible light range can be used as a colorant of an image. Specific examples include “Oil Yellow #101”, “Oil Yellow #103”, “Oil Pink #312”, “Oil Green BG”, “Oil Blue BOS”, “Oil Blue #603”, “Oil Black BY”, “Oil Black BS” and “Oil Black T-505” (each, trade name; product of Orient Chemical Industries, Ltd.) and Victoria Pure Blue, Crystal Violet (CI 42555), Methyl Violet (CI 42535), Ethyl Violet, Rhodamine B (CI 145170B), Malachite Green (CI 42000), Methylene Blue (CI 52015), and dyes as described in Japanese Patent Laid-Open No. 293247/1087. Pigments such as phthalocyanine pigments, azo pigments, carbon black and titanium oxide can also be used preferably.

The addition of these colorants is preferred because it enables easy distinction between image areas and non-image areas after image formation. The colorant is added preferably in an amount of from 0.01 to 10 mass %, based on the total solid content in the image recording material.

Visualizing Agent

To the image recording layer of the invention, a compound which discolors by an acid or radical can be added in order to form a print-out image. As such a compound, various dyes such as diphenylmethane, triphenylmethane, thiazine, oxazine, xanthene, anthraquinone, iminoquinone, azo and azomethine dyes are effectively employed.

Specific examples include dyes such as Brilliant Green, Ethyl Violet, Methyl Green, Crystal Violet, Basic Fuchsin, Methyl Violet 2B, Quinaldine Red, Rose Bengal, Metanil Yellow, thymolsulfophthalein, Xylenol Blue, Methyl Orange, Paramethyl Red, Congo Red, Benzopurpurin 4B, α-Naphthyl Red, Nile Blue 2B, Nile Blue A, Methyl Violet, Malachite Green, Parafuchsin, “Victoria Pure Blue BOH” (trade name; product of Hodogaya Chemical), “Oil Blue #603” (trade name; product of Orient Chemical Industries), “Oil Pink #312” (trade name; product of Orient Chemical Industries), “Oil Red 5B” (trade name; product of Orient Chemical Industries), “Oil Scarlet #308” (trade name; product of Orient Chemical Industries), “Oil Red OG” (trade name; product of Orient Chemical Industries), “Oil Red RR” (trade name; product of Orient Chemical Industries), “Oil Green #502” (trade name; product of Orient Chemical Industries), “Spiron Red BEH Special” (trade name; product of Hodogaya Chemical), m-Cresol Purple, Cresol Red, Rhodamine B, Rhodamine 6G, Sulforhodamine B, Auramine, 4-p-diethylaminophenyliminonaphthoquinone, 2-carboxyanilino-4-p-diethylaminophenyliminonaphthoquinone, 2-carboxystearylamino-4-p-N,N-bis(hydroxyethyl)amino-phenyliminonaphthoquinone, 1-phenyl-3-methyl-4-p-diethylaminophenylimino-5-pyrazolone and 1-β-naphthyl-4-p-diethylaminophenylimino-5-pyrazolone; and leuco dyes such as p,p′,p”-hexamethyltriaminotriphenylmethane (Leuco Crystal Violet) and “Pergascript Blue SRB” (trade name; product of Ciba Geigy).

Leuco dyes known as a material for heat-sensitive or pressure-sensitive paper are also suited as well as the above-described dyes. Specific examples include Crystal Violet Lactone, Malachite Green Lactone, Benzoyl Leucomethylene Blue, 2-(N-phenyl-N-methylamino)-6-(N-p-tolyl-N-ethyl)amino-fluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyridino-6-methyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide.

The dye which discolors by an acid or radical is preferably added in an amount of from 0.01 to 10 wt %, based on the total solid content in the image recording layer.

Polymerization Inhibitor

Addition of a small amount of a thermal polymerization inhibitor to the image recording layer of the invention is preferred in order to prevent undesired thermal polymerization of the polymerizable compound (E) during preparation or storage of the image recording layer.

Preferred examples of the thermal polymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol) and N-nitroso-N-phenylhydroxylamine aluminum salt.

The thermal polymerization inhibitor is preferably added in an amount of from about 0.01 to about 5 mss %, based on the total solid content in the image recording layer.

Higher Fatty Acid Derivative or the Like

To prevent the polymerization inhibition due to oxygen, a higher fatty acid derivative or the like such as behenic acid or behenamide may be added so as to concentrate it on the surface of the image recording layer during drying after application. The higher fatty acid derivative is preferably added in an amount of from about 0.1 to about 10 mass %, based on the total solid content in the image recording layer.

Plasticizer

The image recording layer of the invention may contain a plasticizer to improve the on-machine developability.

Preferred examples of the plasticizer include phthalate esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate and diallyl phthalate; glycol esters such as dimethyl glycol phthalate, ethyl phthalyl ethyl glycolate, methyl phthalyl ethyl glycolate, butyl phthalyl butyl glycolate, and triethylene glycol dicaprylate; phosphate esters such as tricresyl phosphate and triphenyl phosphate; aliphatic dibasic acid esters such as diisobutyl adipate, dioctyl adipate, dimethyl sebacate, dibutyl sebacate, dioctyl azelate and dibutyl maleate; and polyglycidyl methacrylate, triethyl citrate, glycerin triacetyl ester and butyl laurate.

The content of the plasticizer is preferably about 30 mass % or less, based on the total solid content in the image recording layer.

Hydrophilic Compound

The image recording layer of the invention may contain a hydrophilic compound in order to improve the on-machine developability. As the hydrophilic compound, for example, hydroplilic low molecular compounds and hydrophilic high molecular compounds can be mentioned.

Examples of the hydrophilic low molecular compounds include water-soluble organic compounds, more specifically, glycols such as ethylene glycol, diethylene glycol, triethylene glycol, propylene glycol, dipropylene glycol and tripropylene glycol, and esters or ester derivatives thereof; polyhydroxy compounds such as glycerin and pentaerythritol; organic amines such as triethanolamine, diethanolamine and monoethanolamine, and salts thereof; organic sulfonic acids such as toluenesulfonic acid and benzenesulfonic acid, and salts thereof; organic phosphonic acids such as phenylphosphonic acid, and salts thereof; and organic carboxylic acids such as tartaric acid, oxalic acid, citric acid, malic acid, lactic acid, gluconic acid and amino acid, and salts thereof.

Examples of the hydrophilic high molecular compounds include gum arabic, casein, gelatin, starch derivatives, carboxymethyl cellulose and sodium salt thereof, cellulose acetate, sodium alginate, vinyl acetate-maleic acid copolymer, styrene-maleic acid copolymer, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a degree of hydrolysis of at least 60 mass %, preferably at least 80 mass %, polyvinyl formal, polyvinyl butyral, polyvinylpyrrolidone, homopolymers and copolymers of acrylamide, homopolymers and copolymers of methacrylamide, homopolymers and copolymers of N-methylolacrylamide, alcohol-soluble nylon and a polyether of 2,2-bis(4-hydroxyphenyl)propane with epichlorohydrin.

Formation of Image Recording Layer

The image recording layer of the invention is formed by dispersing or dissolving the above-described necessary components in a solvent to prepare a coating dispersion or solution and applying it to a support. Examples of the solvent to be used here include, but not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, y-butyrolactone, toluene, acetone and water. They may be used either singly or in combination. The solid content concentration of the coating dispersion or solution is preferably from 1 to 50 mass %.

It is also possible to disperse or dissolve the above-described components in a solvent and thus, prepare a plurality of coating dispersions or solutions which may have the same or different composition dispersed or dissolved in the same or different solvent; and form the image recording layer of the invention by repeating application of them and drying in plural times.

Although the amount (solid content) of the image recording layer formed on a support by application and drying varies depending on the using purpose, an amount of from 0.3 to 3.0 g/m² is generally preferred. Within this range, good sensitivity and good film forming properties of the image recording layer can be attained.

A variety of application methods can be used. Examples include bar coating, spin coating, spray coating, curtain coating, dip coating, air knife coating, blade coating and roll coating.

Support

Any support can be used for the lithographic printing plate precursor of the invention without particular limitation insofar as it is a dimensionally stable sheet or plate. Examples include paper, paper laminated with plastic (e.g., polyethylene, polypropylene, polystyrene), metal plate (e.g., aluminum, zinc, copper), plastic film (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal), and paper or plastic film on which the above metal has been laminated or vapor deposited. Preferred supports include polyester film and aluminum sheet. Of these, aluminum sheet is especially preferred for its good dimensional stability and relatively low cost.

The aluminum sheet may be a sheet of pure aluminum, an alloy sheet composed mainly of aluminum and containing trace amounts of the other elements, or a thin film of aluminum or aluminum alloy laminated with plastic. The other elements contained in the aluminum alloy are silicon, iron, manganese, copper, magnesium, chromium, zinc, bismuth, nickel and titanium and the like. The content of these other elements in the alloy is preferably 10 mass % or less. In the invention, a pure aluminum sheet is preferred, but in consideration of the present refining technology having difficulty in preparing completely pure aluminum, an aluminum sheet containing a trace amount of the other elements is acceptable. The composition of the aluminum sheet is not specified and any material known and used in the art can be used as needed.

The support has preferably a thickness of from 0.1 to 0.6 mm, more preferably from 0.15 to 0.4 nm, still more preferably from 0.2 to 0.3 mm.

The aluminum sheet is preferably subjected to surface treatment such as roughening treatment and anodizing treatment prior to its use. The surface treatment improves hydrophilic property and facilitates the retention of adhesion between the image recording layer and support. Prior to the surface roughening treatment, the aluminum sheet is degreased, if desired, by a surfactant, organic solvent or aqueous alkaline solution to remove the rolling oil from the surface.

A variety of methods are adopted for the surface roughening of the aluminum sheet. Examples of the method include mechanical roughening treatment, electrochemical roughening treatment (in which the surface is electrochemically dissolved) and chemical roughening treatment (in which the surface is selectively dissolved chemically).

The mechanical surface roughening treatment can be carried out by a known method such as ball grinding, brushing, blasting or buffing.

The electrochemical surface roughening treatment can be carried out by treating the surface with an alternating current or direct current in an electrolytic solution containing an acid such as hydrochloric aid or nitric acid. This treatment can be carried out by using an acid mixture as described in Japanese Patent Laid-Open No. 63902/1979.

After the surface roughening treatment, the aluminum sheet is subjected to alkali etching treatment, if necessary, with an aqueous solution of potassium hydroxide, sodium hydroxide or the like, neutralized and then, anodized, if desired, to heighten abrasion resistance.

For the anodization of the aluminum sheet, various electrolytes capable of forming a porous oxide film can be used. Sulfuric acid, hydrochloric acid, oxalic acid or chromic acid, or a mixture thereof is usually employed. The concentration of the electrolyte is determined as needed, depending on the kind of the electrolyte.

Although the anodization conditions cannot be determined in a wholesale manner, because they vary depending on the electrolyte used therefor, the preferred conditions are usually as follows: use of a solution having an electrolyte concentration of from 1 to 80 mass %, solution temperature at from 5 to 70° C., current density at from 5 to 60 A/dM², voltage of from 1 to 100 V, and electrolysis period for from 10 seconds to 5 minutes. The weight of the film formed by anodization is preferably from 1.0 to 5.0 g/m², more preferably from 1.5 to 4.0 g/m². Within this range, good printing resistance and good scuff resistance on a non-image area of a lithographic printing plate can be attained.

As the support to be used in the invention, the above-described substrate having an anodic oxide film formed as a result of the above-described surface treatment can be used as is. In order to improve the adhesion with the upper layer, hydrophilic property, contamination resistance and heat insulation further, however, it is possible to carry out an additional treatment as needed by selecting a proper one from enlarging treatment of micropores of the anodic oxide film, sealing treatment of micropores, and surface hydrophilizing treatment to dip the substrate in an aqueous solution containing a hydrophilic compound, as described in Japanese Patent Laid-Open No. 2001-253181 and 2001-322365.

As the hydrophilizing treatment, the alkali metal silicate method as described in U.S. Pat. Nos. 2,714,066, 3,181,461, 3,280,734 and 3,902,734 can be employed. In this method, the support is immersed or electrolyzed in an aqueous solution of sodium silicate or the like. Additional examples of the hydrophilizing treatment include treatment with potassium fluorozirconate as described in Japanese Patent Laid-Open No. 22063/1961, and treatment with polyvinylphosphonic acid as described in U.S. Pat. Nos. 3,276,868, 4,153,461 and 4,689,272.

When a support having a surface with insufficient hydrophilic property such as polyester film is used as the support in the invention, it is preferred to make the surface hydrophilic by forming a hydrophilic layer on the surface. Preferred examples of the hydrophilic layer include a hydrophilic layer, as described in Japanese Patent Laid-Open No. 2001-199175, obtained by applying a coating solution containing a colloid of an oxide or hydroxide of at least one element selected from beryllium, magnesium, aluminum, silicon, titanium, boron, germanium, tin, zirconium, iron, vanadium, antimony and transition metals; a hydrophilic layer containing an organic hydrophilic matrix, as described in Japanese Patent Laid-Open No. 2002-79772, available by crosslinking or pseudo crosslinking of an organic hydrophilic polymer; a hydrophilic layer having an inorganic hydrophilic matrix available by the sol-gel process comprising hydrolysis and condensation of polyalkoxysilane, titanate, zirconate or aluminate; and a hydrophilic layer made of an inorganic thin film having a surface containing a metal oxide. Of these, the hydrophilic layer available by applying a coating solution containing a colloid of an oxide or hydroxide of silicon is preferred.

When a polyester film or the like is employed as the support of the invention, it is preferred to dispose an antistatic layer on the hydrophilic layer side of the support or a side opposite thereto, or both sides. The antistatic layer disposed between the support and the hydrophilic layer also contributes to improve the adhesion with the hydrophilic layer. As the antistatic layer, a polymer having metal oxide fine particles or matting agent dispersed therein, as described in Japanese Patent Laid-Open No. 2002-79772 can be used.

The support has preferably a centerline average roughness of from 0.10 to 1.2 μm. Within this range, good adhesion with the image recording layer, good printing resistance and good contamination resistance can be attained.

The support has preferably a reflection density of from 0.15 to 0.65 as a color density. Within this range, good image forming property and good post-development checking property can be achieved owing to halation prevention upon image exposure.

Back Coat Layer

After the surface treatment on the support or formation of an undercoat layer, a back coat may optionally be provided on the back side of the support.

Preferred examples of the back coat include a coat layer made of an organic high molecular compound as described in Japanese Patent Laid-Open No. 45885/1993 and a coat layer made of a metal oxide available by hydrolysis and polycondensation of an organic metal compound or inorganic metal compound as described in Japanese Patent Laid-Open No. 35174/1994. Of these, alkoxy compounds of silicon such as Si(OCH₃)₄, Si(OC₂H₅)₄, Si(OC₃H₇)₄ and Si(OC₄H₉)₄ are preferred owing to the low cost and easy availability of the raw material.

Undercoat Layer

In the lithographic printing plate precursor of the invention, an undercoat layer may be provided if necessary between the image recording layer and the support. Use of the undercoat layer is advantageous for heightening sensitivity, because it functions as a heat-insulating layer, making it possible to efficiently utilize the heat generated by exposure to the infrared laser without diffusing it into the support Moreover, in a non-image area, the undercoat layer facilitates separation of the image recording layer from the support, improving the on-machine developability.

Specific preferred examples of the undercoat layer include a silane coupling agent having an addition polymerizable ethylenic double bond reactive group and a phosphorus compound having an ethylenic double bond reactive group, as described in Japanese Patent Laid-Open No. 282679/1998.

The coating weight (solid content) of the undercoat layer is preferably from 0.1 to 100 mg/M², more preferably from 3 to 30 mg/m².

Protective Layer

In the lithographic printing plate precursor of the invention, a protective layer may be provided, as needed, on the image recording layer in order to prevent generation of scuff, block oxygen, and prevent ablation upon exposure to high-illuminance laser.

In the invention, exposure is ordinarily carried out in the atmosphere. The protective layer prevents oxygen and low-molecular-weight compounds such as basic substances, which are present in the atmosphere and would otherwise disturb the image forming reactions triggered by light exposure in the image recording layer, from entering the image recording layer, and prevents the image forming reaction by exposure in the atmosphere from being disturbed. The protective layer is therefore desired to have a low permeability to a low-molecular-weight compound such as oxygen. Moreover, the protective layer having good permeability to light used for exposure and excellent adhesion to the image recording layer, and facilitating its removal in the on-press development step after exposure is more preferred. Various protective layers with such properties have been investigated so far and the results of it are described in detail, for example, in U.S. Pat. No. 3,458,311 and Japanese Patent Laid-Open No. 49729/1980.

As a material used for the protective layer, water soluble polymer compounds having a relatively good crystallinity can be used. Specific examples of such a water soluble polymer include polyvinyl alcohol, polyvinylpyrrolidone, acidic celluloses, gelatin, gum arabic and polyacrylic acid. Of these, the use of polyvinyl alcohol (PVA) as a main component brings about the best effects for basic properties such as oxygen blocking property and removability of the protective layer during development. Insofar as the polyvinyl alcohol has an unsubstituted vinyl alcohol unit for imparting the protective layer with necessary oxygen blocking property and water solubility, it may be partially substituted with an ester, ether or acetal, or it may partially have another copolymer component.

As the polyvinyl alcohol, those having a hydrolysis ratio of from 71 to 100% and a polymerization degree of from 300 to 2400 are preferred. Specific examples include “PVA-105”, “PVA-110”, “PVA-117”, “PVA-117”, “PVA-120”, “PVA-124”, “PVA-124”, “PVA-CS”, “PVA-CST”, “PVA-HC”, “PVA-203”, “PVA-204”, “PVA-205”, “PVA-210”, “PVA-217”, “PVA-220”, “PVA-224”, “PVA-217EE”, “PVA-217E”, “PVA-220E”, “PVA-224E”, “PVA-405”, “PVA-420”, “PVA-613” and “L-8”, each product of Kuraray Co., Ltd.

Components constituting the protective layer (choice of PVA, use of additives, etc.) and coating weight may be selected as needed in consideration of not only the oxygen blocking property and the development removability, but also antifogging properties, adhesion, and scuff resistance of the protective layer. In general, when a hydrolysis ratio of the PVA is higher (in other words, the content of unsubstituted vinyl alcohol units in the protective layer is higher) and a film thickness is greater, oxygen blocking property becomes high, which results in better sensitivity. In order to avoid occurrence of unnecessary polymerization reaction upon production and storage and to prevent unnecessary fogging and thickening of image lines upon image exposure, excessively high oxygen permeability is not preferred. The oxygen permeability A at 25° C. under 1 atmospheric pressure preferably satisfies the following equation: 0.2≦A≦20 (cc/m²-day).

As another composition of the protective layer, glycerin, dipropylene glycol or the like can be added to the (co)polymer in an amount of several mass % to impart the protective layer with flexibility. It is also possible to add, to the (co)polymer, an anionic surfactant such as sodium alkyl sulfate or sodium alkylsulfonate; an amphoteric surfactant such as alkylaminocarboxylate or alkylaminodicarboxylate; or a nonionic surfactant such as polyoxyethylene alkylphenyl ether in an amount of several mass %.

The thickness of the protective layer from 0.1 to 5 μm is adequate, with from 0.2 to 2 μm being especially preferred.

Upon handling of the lithographic printing plate precursor, adhesion with an image area and scuff resistance are also very important factors. When the protective layer which is hydrophilic because of the water soluble polymer compound contained therein is stacked over the image recording layer which is lipophilic, the protective layer tends to peel owing to the insufficient adhesive power, which sometimes causes defects such as inferior film curing due to polymerization inhibition by oxygen at the peeling portion.

Various proposals have been made with a view to improving adhesion between the image recording layer and the protective layer. For example, Japanese Patent Laid-Open No. 70702/1974 and GB Patent No. 1303578 describe that sufficient adhesion can be achieved by mixing 20 to 60 mass % of an acrylic emulsion and a water-insoluble vinylpyrrolidone-vinyl acetate copolymer in a hydrophilic polymer composed mainly of polyvinyl alcohol, and stacking the resulting mixture over the image recording layer. Any such known art may be employed for this purpose in the invention. Coating methods to form the protective layer are described for example, in U.S. Pat. No. 3,458,311 and Japanese Patent Laid-Open No. 49729/1980.

The protective layer is able to have another function. For example, by the addition of a colorant (e.g., a water-soluble dye) which has an excellent transmittance to the infrared light used for exposure and can efficiently absorb light of other wavelengths, the suitability of the lithographic printing plate precursor for safelight can be improved without lowering sensitivity.

Exposure

In the lithographic printing method of the invention, the above-described lithographic printing plate precursor is imagewise exposed using an infrared laser.

Although there is no particular limitation imposed on the infrared laser used in the invention, solid lasers and semiconductor lasers which emit infrared light having a wavelength of from 760 to 1200 nm are preferred. The infrared laser has preferably an output of at least 100 mW. To shorten the exposure time, the use of a multi-beam laser device is preferred.

The exposure time per pixel is preferably within 20 μs. The amount of emitted energy is preferably from 10 to 300 mJ/cm².

[Printing]

In the lithographic printing method of the present invention, as described above, printing is carried out by, after imagewise exposure of the lithographic printing plate precursor of the invention to an infrared laser, feeding the plate with an oil-based ink and aqueous component without causing the exposed plate to pass through a development step.

Specific examples include a method of carrying out printing by exposing the lithographic printing plate precursor to an infrared laser, and without causing the exposed plate to pass through a development step, attaching the plate onto the cylinder of a printing press; and a method of attaching the lithographic printing plate precursor to the cylinder of a printing press, exposing the plate to an infrared laser on the printing press and then carry out printing without causing it to pass through the development step.

When printing is carried out by subjecting the lithographic printing plate precursor to imagewise exposure to an infrared laser and, without causing the plate to pass through the development step such as wet development, feeding the plate with the aqueous component and oil-based ink, the image recording layer cured by the exposure forms an oil-based ink receptor having an lipophilic surface in an exposed area of the image recording layer. In an unexposed area, on the other hand, the uncured image recording layer is at least partially removed and from this portion, the hydrophilic surface of the plate appears.

As a result, the aqueous component adheres to the exposed hydrophilic surface, the oil-based ink deposits on the light-exposed area of the image recording layer, and printing begins. Although either the aqueous component or the oil-based ink may be supplied first to the plate surface, it is preferred to initially supply the oil-based ink in order to prevent the aqueous component from being contaminated by the image recording layer in unexposed areas of the plate. As the aqueous component and the oil-based ink, ordinarily employed fountain solution and printing ink are used.

In such a manner, the lithographic printing plate precursor is developed on an offset printing press, and used as is for printing of a large number of impressions.

### EXAMPLES

The present invention will hereinafter be described in detail by Examples and Comparative Examples. It should however be borne in mind that the invention is not limited to or by them.

Synthesis of Image Forming Particles

Synthesis of Image Forming Particles (Microcapsule Particles) (1)

As an oil phase component, 10 g of an adduct of xylene diisocyanate with trimethylolpropane (“Takenate D-110N”, trade name; product of Mitsui Takeda Chemicals), 3.15 g of pentaerythritol triacrylate (“SR444”, trade name; product of Nippon Kayaku), 0.35 g of the below-described infrared absorber (1), 1 g of 3-(N,N-diethylamino)-6-methyl-7-anilinofluoran (“ODB”, trade name; product of Yamamoto Chemicals.), and 0.1 g of “Pionin A-41C” (trade name; product of Takemoto Oil & Fat) were dissolved in 17 g of ethyl acetate. As an aqueous phase component, 40 g of a 4 mass % aqueous solution of “PVA-205” (trade name; product of Kuraray, saponification degree: 88%, I/O value: 2.1) was prepared. The oil phase component and the aqueous phase component were mixed, followed by emulsification in a homogenizer at 12,000 rpm for 10 minutes. The emulsion thus obtained was added to 25 g of distilled water. After stirring at room temperature for 30 minutes, stirring was conducted further at 40° C. for 3 hours. The microcapsule solution (1) thus obtained was diluted with distilled water to give its solid concentration of 15 mass %. The microcapsule thus obtained had an average particle size of 0.27 μm. 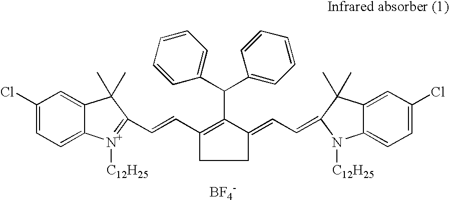
Synthesis of Image Forming Particles (Microcapsule Particles) (2)

In a similar manner to the above-described method for synthesizing the microcapsule (1) except for the use of “MP-103” (trade name of alkyl-ternninated PVA, product of Kuraray, saponification degree: 98.5%, I/O value: 2.4) instead of “PVA-205”, a microcapsule (2) was synthesized. It had an average particle size of 0.22 μm.

Synthesis of Image Forming Particles (Microcapsule Particles) (3)

In a similar manner to the above-described method for synthesizing the microcapsule (1) except for the use of “Duckloid LF” (trade name; product of Kibun Food Chemifa, I/O value: 2.2) instead of “PVA-205”, a microcapsule (3) was synthesized. It had an average particle size of 0.35 μm.

Synthesis of Image Forming Particles (Self Water Dispersible Acrylic Polymer Particles) (4)

In a 1 L four-necked flask equipped with a stirrer, a condenser, a nitrogen inlet, a dropping funnel and a thermometer, 300 g of methyl ethyl ketone was charged and heated to 75° C. A solution obtained by thoroughly mixing 60 g of styrene, 320 g of methyl methacrylate, 30 g of methacrylic acid, and 6 g of 2,2′-azobis(isobutyric acid)dimethyl (“V-601”, trade name of a polymerization initiator which is a product of Wako Pure Chemicals) was added dropwise over 3 hours. After stirring for 10 hours, 0.8 g of “V-601” was added and the mixture was stirred further for 10 hours, whereby an acrylic polymer having a dry solid content ratio of 35%, an acid value of 29.6 and a weight average molecular weight of 45000 was obtained. With 6 g of triethylamine, 200 g of the above-described acrylic polymer solution was neutralized. Under stirring, water was added dropwise to the solution. The solution gradually has an increased viscosity. After completion of the dropwise addition of about 250 g of water, on the other hand, the viscosity lowered remarkably, whereby phase inversion was completed. After further addition of 200 g of water, the dispersion thus obtained was heated to 45° C. to remove the organic solvent and excess water under reduced pressure, whereby a water dispersion of acrylic polymer fine particles having a dry solid content ratio of 29.5% and an average particle size of 0.10 μm was obtained.

Synthesis of Image Forming Particles (Self Water Dispersible Polyurethane Particles) (5)

In a 1 L four-necked flask equipped with a stirrer, a condenser, a dry nitrogen inlet and a thermometer, 200 g of “BURNOCK DN-980” (trade name of polyisocyanate, product of Dainippon Ink & Chemicals), 10 g of 2,2-bis(hydroxymethyl)propionic acid, 0.03 g of dibutyltin dilaurate and 200 g of ethyl acetate were charged, followed by stirring at 65° C. for 5 hours, whereby a prepolymer solution of polyurethane having a dry solid content ratio of 45.0%, and an isocyanate group content of 6.20% was obtained. To 150 g of the resulting polyurethane prepolymer solution was added 50 g of methyl ethyl ketone, followed by neutralization with 5 g of triethylamine. Under stirring, water was added dropwise to the resulting solution. The prepolymer solution thickened gradually. After the addition of about 400 g of water, an aqueous solution obtained by dissolving 3 g of diethylenetriamine in 70° C. of water was added in portions while stirring. The resulting dispersion was heated to 45° C. to remove the organic solvent and excess water under reduced pressure, whereby an aqueous dispersion of urethane fine particles having a dry solid content ratio of 29% and average particle size of 0.09 μm was obtained. It had an acid value of 28.4.

Synthesis of Image Forming Particles (Self Water Dispersible Polyurethane Particles) (6)

In a 500-mL flask equipped with a condenser, a mechanical stirrer, a thermometer, a nitrogen inlet/outlet and two monomer feed pipes, 30 μl of a uniform mixture of 15 g of acrylic acid, 5 g of styrene, 1 g of methyl acrylate, 2 g of benzoyl peroxide (BPO) and 50 g of n-butanol was charged. While stirring, the resulting mixture was heated for 3 hours at a temperature kept at 100° C. The reaction mixture was cooled down to room temperature, followed by the addition of 150 ml of distilled water and 5 ml of 25% aqueous ammonia. The resulting mixture was stirred until it became transparent Then, 0.7 g of ascorbic acid and 1 g of potassium persulfate were added. To the resulting mixture were added 40 g of styrene, 2 g of glycidyl methacrylate and 1.5 g of bromotrichloromethane. After the temperature was raised to 38° C. under a nitrogen atmosphere, the mixture was maintained at the same temperature for 8 hours. The resulting product had a solid content of 18%. The particles had, as a core, a styrene/glycidyl methacrylate copolymer and as a shell material, carboxylated acrylate copolymer which associates with the core.

Synthesis of Image Forming Particles (Self Water Dispersible Core Shell Particles) (7)

In a reaction vessel, 30 g of bisphenol A was added to 70 g of a liquid epoxy resin “DER 333” (trade name of catalyst-added epoxy resin, product of Dow Chemical, epoxy equivalent: about 200). While stirring, the resulting mixture was heated to 170° C. over about 1 hour and kept at this temperature for 3 hours. The reaction product thus obtained was an epoxy resin having an epoxy equivalent of about 2000. The reaction vessel was equipped with a reflux condenser. After the system was hermetically sealed, 100 g of n-butanol was poured by using a pump, whereby a solution of the above-described epoxy resin was obtained. The solution was kept at 100° C. In another container were charged 10 g of methacrylic acid, 10 g of styrene, 10 g of methyl acrylate and 2.5 g of benzoyl peroxide and they were mixed.

The resulting monomer mixture was added to the reaction vessel containing the epoxy resin at a certain rate over 150 minutes. The reaction temperature was kept at 110 to 112° C. After the completion of the addition of the monomer mixture, stirring was continued for 4 hours to obtain a half cloudy reaction product dispersed in n-butanol.

The resin dispersion thus obtained was added in portions to a mixture of 300 g of deionized water and 20 g of dimethylethanolamine heated to 60° C. After stirring for about 1 hour, 200 g of deionized water was added. At this stage, the resin which was the reaction product was finely dispersed and became milky white. The aqueous dispersion was distilled under pressure at from 40 to 50° C., by which 150 g was distilled off. The resulting aqueous dispersion was washed using an ultrafiltration module (“ACP-1050”, trade name; product of Asahi Kasei). In the aqueous dispersion thus obtained, the resin was finely dispersed and the dispersion was milky white. This aqueous solution was free from coagulation or precipitation and did not lose its stability even if it was left alone for 6 months. The dispersion had a nonvolatile content of 17% and n-butanol in the dispersion was not detected as a result of the analysis by gas chromatography.

Synthesis of Image Forming Particles (Self Water Dispersible Core Shell Particles) (8)

In a four-necked flask purged with a nitrogen gas were charged 100 g of n-butanol and 120 g of bisphenol F type epoxy resin to dissolve the latter in the former by heating. To the resulting solution, a uniform mixture of 20 g of methacrylic acid, 8 g of styrene, 1 g of methyl acrylate, 2 g of benzoyl peroxide (BPO) and 12 g of n-butanol was added dropwise over 1 hour under stirring while maintaining the temperature in the flask at 100° C. After completion of the dropwise addition, the stirring was continued for 3 hours at the same temperature to obtain a solution of a carboxyl-containing self emulsifiable epoxy resin having a solid content of 52%. In a four-necked flask with a nitrogen gas sealed therein, 70 g of the self emulsifiable epoxy resin was charged and heated to 110° C. A mixture of 2 g of dimethylethanolamine and 150 g of deionized water was added dropwise over 5 minutes while stirring, whereby an aqueous dispersion of the epoxy resin having a carboxyl group and at the same time, having self emulsifying property was obtained. Under reduced pressure, 60 g of n-butanol and water was distilled off by azeotropic distillation, whereby an aqueous dispersion of the carboxyl-containing self-emulsifiable epoxy resin (A) having a nonvolatile content of 21% and being free of a solvent was obtained. In an autoclave equipped with a stirring apparatus and purged with a nitrogen gas were charged 50 g of the resulting aqueous dispersion, 2.5 g of butadiene, 2 g of styrene and 0.2 g of BPO. While stirring, the resulting mixture was heated to 55° C. When stirring was continued until the internal pressure became 2 Kg/cm², a target aqueous resin composition having a solid content of 22.5% was obtained. The resulting aqueous resin composition underwent no change in viscosity even after 3 months.

Synthesis of Image Forming Particles (Silica Dispersed Acrylic Polymer Particles) (9)

As an oil phase component, a solution of 15.0 g of poly(methyl methacrylate) (weight average molecular weight: 120,000), 25.0 g of MEK and 0.3 g of “Pionin A41C” (trade name of surfactant, product of Takemoto Oil & Fat) was prepared, while as an aqueous phase component a solution of 20 g of “SNOWTEX C” (trade name of a 20% aqueous solution of colloidal silica, product of Nissan Chemical) and 180 g of water was prepared. After mixing of these solutions, the mixture was vigorously stirred by a homogenizer at 11,000 rpm for 15 minutes, whereby an emulsified dispersion having oil droplets dispersed in an aqueous phase was obtained. In a stainless pot, the resulting emulsified dispersion was charged. The solvent component was removed by stirring at 60° C. for 3 hours, whereby hydrophobic polymer fine particles having a particle size of 0.26 μm was obtained.

Synthesis of Image Forming Particles (Water Soluble Resin Dispersed Acrylic Polymer Particles) (10)

As an oil phase component, a solution of 5.0 g of poly(methyl methacrylate) (weight average molecular weight: 120,000), 10 g of glycidyl methacrylate, 25.0 g of MEK and 0.3 g of “Pionin A41C” (trade name of a surfactant, product of Takemoto Oil & Fat) was prepared, while as an aqueous phase component, a solution of 20 g of “PVA-405” (trade name; product of Kuraray, saponification degree: 81.5%, I/O value: 2.0) and 150 g of water was prepared. After mixing of these solutions, the mixture was vigorously stirred by a homogenizer at 12,000 rpm for 10 minutes, whereby an emulsified dispersion having oil droplets dispersed in an aqueous phase was obtained. In a stainless pot, the resulting emulsified dispersion was charged. The solvent component was removed by stirring at 60° C. for 3 hours, whereby hydrophobic polymer fine particles having a particle size of 0.32 μm was obtained.

### Example 1

1. Preparation of Lithographic Printing Plate Precursor

(1) Preparation of Support

Aluminum Sheet

A melt of JIS A1050 aluminum alloy containing 99.5 mass % or more of Al, 0.30 mass % of Fe, 0.10 mass % of Si, 0.02 mass % of Ti, 0.013 mass % of Cu and the balance of inevitable impurities was subjected to a cleaning treatment and then cast. In the cleaning treatment, the melt was subjected to degassing treatment for removing unnecessary gases such as hydrogen and then to a ceramic tube filter treatment. For the casting, the DC casting method was employed. The solidified ingot having a plate thickness of 500 mm was scalped to 10 mm from the surface and subjected to homogenization treatment at 550° C. for 10 hours so as to prevent the intermetallic compound from becoming coarse. The sheet was then hot-rolled at 400° C., subjected to intermediate annealing at 500° C. for 60 seconds in a continuous annealing furnace, and then cold-rolled to obtain an aluminum rolled sheet having a thickness of 0.30 mm. By controlling the roughness of the rolling roller, the centerline average surface roughness Ra after the cold rolling was controlled to 0.2 μm. The sheet was then applied with a tension leveler to improve the planarity. The aluminum sheet thus obtained was then subjected to the surface treatments as described below.

The aluminum sheet was first degreased with a 10 mass % aqueous solution of sodium aluminate solution at 50° C. for 30 seconds to remove the rolling oil from the surface of the aluminum sheet and then neutralized and desmutted with a 30 mass % aqueous solution of sulfuric acid at 50° C. for 30 seconds.

The resulting aluminum sheet was then subjected to surface roughening treatment so as to attain good adhesion between the image recording layer and the support and at the same time to impart water retention property to the non-image area. More specifically, the sheet was subjected to electrochemical surface-roughening treatment by electrolyzing at an alternate waveform having a current density of 20 A/dm² and a duty ratio of 1:1 to give its quantity of electricity of 240 C/dm² in the anode side, while causing the web of the aluminum sheet to pass through an aqueous solution (liquid temperature: 45° C.) which had been fed to an indirect current supply cell and contained 1 mass % of nitric acid and 0.5 mass % of aluminum nitrate.

The sheet was then etched with a 10 mass % aqueous solution of sodium aluminate at 50° C. for 30 seconds and then neutralized and desmutted with a 30 mass % aqueous solution of sulfuric acid at 50° C. for 30 seconds.

Anodizing treatment was then carried out so as to improve the abrasion resistance, chemical resistance and water retention. More specifically, 2.5 g/m² of an anodic oxide film was formed on the aluminum sheet by electrolyzing with direct current having a current density of 14 A/dm2 while causing the web of an aluminum sheet to pass through a 20 mass % aqueous solution of sulfuric acid (solution temperature, 35° C.) supplied to an indirect current supply cell.

To ensure the hydrophilic properties of non-image areas, the aluminum sheet was subjected to silicate treatment using a 1.5 mass % aqueous sodium silicate solution No. 3 at 70° C. for 15 seconds. The amount of silicon deposited on the sheet was 10 mg/m². The treated sheet was then rinsed with water, giving the finished support. The support thus obtained had a centerline average roughness Ra of 0.25 μm.

(2) Formation of Image Recording Layer

The bar coating of the support was performed with a coating solution of an image recording layer having the below-described composition, followed by oven drying at 70° C. for 60 seconds to form an image recording layer having a dry coating weight of 0.8 g/m², whereby a lithographic printing plate precursor was obtained.

Coating solution of image recording layer (1)

| | | |
|---|---|---|
| Infrared absorber (2) shown below | 2.0 | g |
| Polymerization initiator (1) shown below | 10.0 | g |
| Non-water-soluble binder (B-1) | 16.2 | g |
| Polymerizable compound | 38.5 | g |
| Isocyanuric acid EO-modified triacrylate | | |
| (“NK Ester M-315”, trade name; product of | | |
| Shin-nakamura Chemical) | | |
| Naphthalenesulfonate of Victoria Pure Blue | 2.0 | g |
| Fluorosurfactant (1) shown below | 1.0 | g |
| 1-Methoxy-2-propanol | 100.0 | g |
| The above-described image forming particles (1) | 40.0 | g |

(in terms of
solid content)

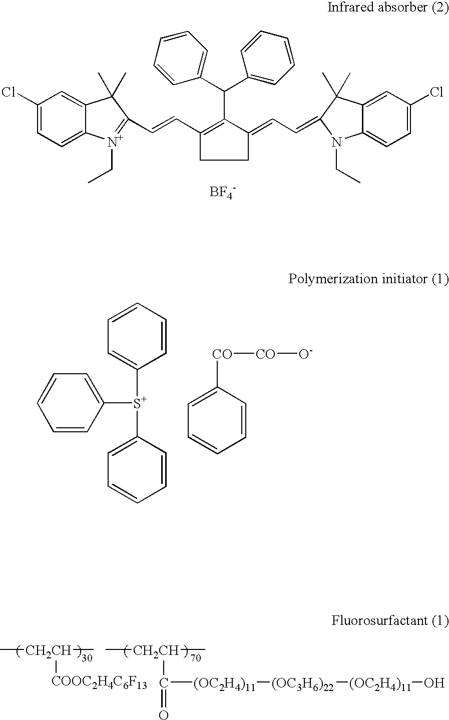 2. Exposure and Printing

The resulting lithographic printing plate precursor was exposed using “Trendsetter 3244 VX” (trade name; product of Creo Inc.) equipped with a water-cooling type 40W infrared semiconductor laser at an output of 9 W, an external drum speed of 210 rpm, and a resolution of 2,400 dpi. The image to be exposed included a line chart. The exposed plate was mounted on the cylinder of a printing press “SOR-M” (trade name; product of Heidelberger Druckmaschinen A G) without the development treatment. After fountain solution (“EU-3”, trade name of an etchant; product of Fuji Photo Film)/water/isopropyl alcohol=1/89/10 by volume) and black ink “TRANS-G (N)” (trade name; product of Dainippon Ink and Chemicals) were supplied to the plate, 100 impressions were printed at a press speed of 6,000 impressions per hour.

After completion of the on-press development of unexposed areas of the image recording layer, the number of sheets of printing paper required until the transfer of the ink to the printing paper stopped was measured as the on-press developability. Within 100 sheets, impressions free of contamination in non-image areas were obtained.

3. Evaluation

The printing durability and one-press development running property of the negative type lithographic printing plate precursor thus obtained were evaluated in the below-described manners. The higher the printing durability, the higher the sensitivity. With regards to the on-press development running property, presence or absence of deposition of development residues after repetition of on-press development and printing was evaluated. The less the deposition on the ink roller, the better running property.

(1) Printing Durability

After printing to evaluate the fine line reproduction in the above-described manner, the printing was continued further. As the number of impressions rose, the image recording layer was gradually worn away and ink receptivity declined, leading to a decrease in the ink density on the printing paper. The printing durability was evaluated based on the number of impressions at which the ink density (reflection density) decreased by 0.1 from that upon starting of the printing. The results are shown in Table 1.

(2) Development Running Property

The on-press development of the exposed lithographic printing plate precursor was carried out as described above, followed by printing of 5000 impressions. This operation was regarded as 1 round. After 10 rounds of this operation composed of the on-press development and printing were conducted continuously, the residues (development dusts) on a dampening roller and inking roller after development were evaluated. The results are shown in Table 1.

### Examples 2 to 17

In a similar manner to Example 1 except that non-water-soluble binders and image forming particles described in Table 1 were employed instead, lithographic printing plate precursors were obtained.

Exposure, printing and evaluation of the resulting lithographic printing plate precursors were performed as in Example 1. The results are shown in Table 1.

As in Example 1, the number of sheets of printing paper required until the transfer of the ink to the printing paper stopped, after completion of the on-press development of unexposed areas of the image recording layer, was measured as the on-machine developability. In any of the lithographic printing plate precursors, impressions free of contamination in non-image areas were obtained within 100 sheets.

### Comparative Example 1

In a similar manner to Example 1 except for the use of polystyrene (I/O value: 0.09) as the non-water-soluble binder, a lithographic printing plate precursor was obtained.

As in Example 1, exposure, printing and evaluation of the resulting lithographic printing plate precursor were performed. The evaluation results are shown in Table 1.

### Comparative Example 2

In a similar manner to Example 1 except the image forming particles were omitted, a lithographic printing plate precursor was obtained.

As in Example 1, exposure, printing and evaluation of the resulting lithographic printing plate precursor were performed. The evaluation results are shown in Table 1.

TABLE 1

| | | I/O value | | | Printing | |
|---|---|---|---|---|---|---|
| | Image | of image | Non-water- | I/O value of | durability | |
| | forming | forming | soluble | non-water- | (the number | Development |
| | particles | particles | binder | soluble binder | of sheets) | dust |
| Ex. 1 | (1) | 2.1 | B-1 | 0.68 | 15,000 | None |
| Ex. 2 | (1) | 2.1 | B-2 | 0.78 | 15,000 | None |
| Ex. 3 | (1) | 2.1 | B-4 | 0.92 | 17,000 | None |
| Ex. 4 | (1) | 2.1 | B-5 | 0.88 | 15,000 | None |
| Ex. 5 | (1) | 2.1 | B-10 | 1.0 | 18,000 | None |
| Ex. 6 | (1) | 2.1 | B-23 | 1.3 | 20,000 | None |
| Ex. 7 | (1) | 2.1 | B-34 | 1.1 | 18,000 | None |
| Ex. 8 | (1) | 2.1 | B-42 | 1.2 | 20,000 | None |
| Ex. 9 | (2) | 2.4 | B-10 | 1.0 | 18,000 | None |
| Ex. 10 | (3) | 2.2 | B-10 | 1.0 | 16,000 | None |
| Ex. 11 | (4) | — | B-10 | 1.0 | 20,000 | None |
| Ex. 12 | (5) | — | B-10 | 1.0 | 20,000 | None |
| Ex. 13 | (6) | — | B-10 | 1.0 | 17,000 | None |
| Ex. 14 | (7) | — | B-10 | 1.0 | 18,000 | None |
| Ex. 15 | (8) | — | B-10 | 1.0 | 16,000 | None |
| Ex. 16 | (9) | — | B-10 | 1.0 | 15,000 | None |
| Ex. 17 | (10) | 2.0 | B-10 | 1.0 | 15,000 | None |
| Comp. | (1) | 2.1 | Poly- | 0.09 | 15,000 | Deposition |
| Ex. 1 | | | styrene | | | started from the |
| | | | | | | third round |
| Comp. | None | — | B-1 | 0.68 | 5,000 | Deposition |
| Ex. 2 | | | | | | started from the |
| | | | | | | first round |

As is apparent from Table 1, the printing durability and development running property were excellent when lithographic printing was performed using the lithographic printing plate precursors (Examples 1 to 17) of the invention compared with printing using the conventional lithographic printing plate precursors (Comparative Examples 1 and 2).

### Examples 18 to 23, Comparative Example 3

(1) Preparation of Support

In order to remove a rolling oil from the surface of an aluminum sheet (material quality: 1050) having a thickness of 0.3 mm, the aluminum sheet was degreased with a 10 mass % aqueous solution of sodium aluminate at 50° C. for 30 seconds, followed by graining of the aluminum surface with 3 bundled bristles-implanted brushes having a bristle diameter of 0.3 mm and a pumice-water suspension (specific gravity: 1.1 g/cm³). The surface was then washed with water sufficiently. The sheet was then etched by immersing it in a 25 mass % aqueous solution of sodium hydroxide at 45° C. for 9 seconds. After washing with water, the sheet was immersed in 20 mass % nitric acid at 60° C. for 20 seconds and washed with water. The etching amount of the grained surface at this time was about 3 g/M².

Electrochemical surface roughening treatment was continuously performed using AC of 60 Hz. The electrolytic solution used here was a 1 mass % aqueous solution of nitric acid (containing 0.5 mass % of aluminum ions) and had a temperature of 50° C. The electrochemical surface roughening treatment was performed with a carbon electrode as a counter electrode by using, as an AC power supply, a trapezoidal rectangular wave AC having a time TP of 0.8 msec necessary for the current value to reach the peak from zero and a duty ratio of 1:1. For an auxiliary anode, ferrite was used. The current density was 30 A/dm² at the peak value of the current and 5% of the current flowing from the power supply was shunted to the auxiliary anode electrode. The quantity of electricity upon nitric acid electrolysis was 175 C/dm² when the aluminum sheet was on the anode side. Rinsing was then performed with a spray.

The aluminum sheet was subjected to electrochemical surface roughening treatment in a similar manner to nitric acid electrolysis under the following conditions: use of, as an electrolyte solution, a 0.5 mass % aqueous solution of hydrochloric acid (containing 0.5 mass % of aluminum ions) having a liquid temperature of 50° C., and the electric quantity of 50 C/dm² when the aluminum sheet was on the anode side. The resulting sheet was washed with water by using a spray. A direct-current anode oxide film of 2.5 g/m² was disposed on the sheet by using 15 mass % sulfuric acid (containing 0.5 mass % of aluminum ions) as an electrolytic solution at a current density of 15A/dm2, followed by pore-sealing treatment by immersing the resulting sheet in a solution containing 0.1 mass % of sodium fluorozirconate and 1 mass % of sodium dihydrogen phosphate, having a pH of 3.7 and heated to 75° C. The resulting sheet was treated further with a 2.5 mass % aqueous solution of sodium silicate at 30° C. for 10 seconds. As a result of measurement of the centerline average roughness (Ra) of the support by using a needle having a diameter of 2 μm, it was 0.51 μm.

(2) Formation of Undercoat Layer

The undercoat solution (1) which will be described later was applied to the above-described support to give a dry coating weight of 10 mg/m², whereby a support having an undercoat layer used in the below-described test was prepared.

<Undercoat solution (1)>

| | | |
|---|---|---|
| Undercoat compound (1) | 0.017 | g |
| Methanol | 9.00 | g |
| Water | 1.00 | g |

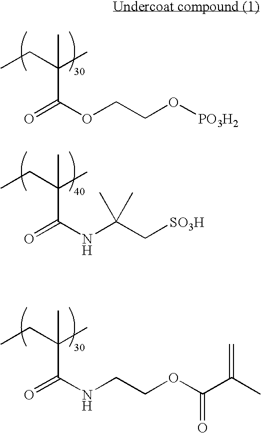 (3) Formation of Image Recording Layer

After bar coating of a coating solution of an image recording layer having the below-described composition on the support having the above-described undercoat layer thereon, the resulting support was oven-dried at 100° C. for 60 seconds to form an image recording layer having a dry coating weight of 1.0 g/m². A lithographic printing plate precursor was thus obtained.

The coating solution of an image recording layer was obtained by mixing and stirring the below-described sensitizing solution and a microcapsule solution just before application.

| | |
|---|---|
| <Sensitizing Solution> | |
| Polymer binder as described in Table 2 | Amount as described |
| | in Table 2 |
| Below-described polymerization initiator (1) | 0.100 g |
| Below-described infrared absorber (1) | 0.020 g |
| Polymerizable monomer “ARONIX M-215” | Amount as described |
| (trade name; product of TOAGOSEI Co., Ltd.) | in Table 2 |
| Below-described fluorosurfactant (1) | 0.044 g |
| MEK | 1.091 g |
| MFG | 8.609 g |
| <Microcapsule Solution> | |
| Microcapsule (11) synthesized in the | 2.640 g |
| below-described manner | |
| Water | 2.425 g |

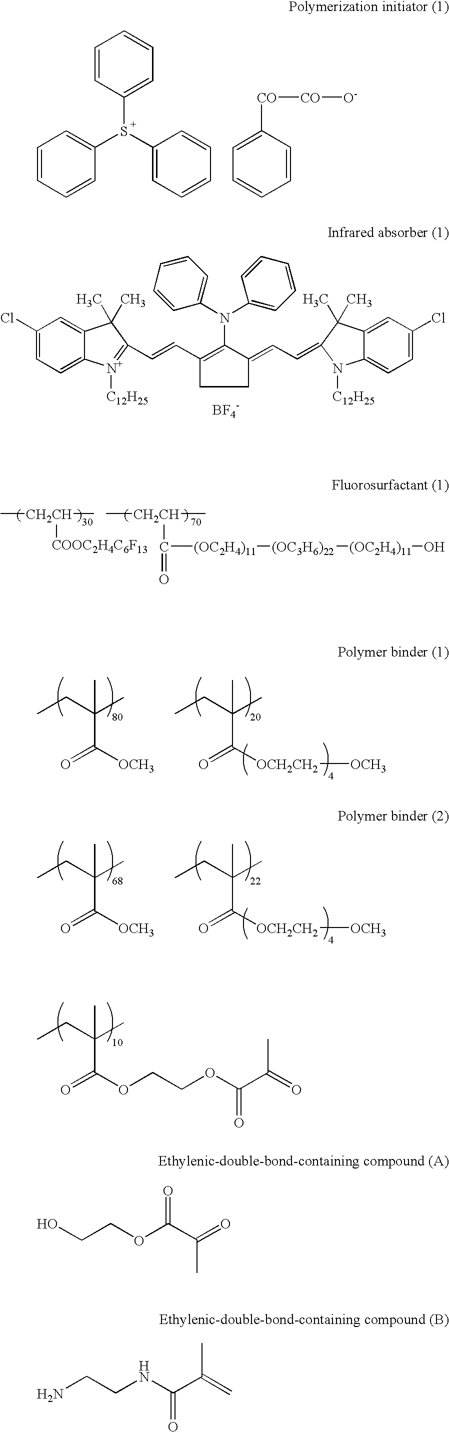 Synthesis of Microcapsule (11)

As an oil phase component, 10.0 g of an adduct of xylene diisocyanate with trimethylolpropane (“Takenate D-110N”, trade name; product of Mitsui Takeda Chemicals), 6.00 g of “ARONIX M-215” (trade name of polyinerizable monomer; product of TOAGOSEI), 0.75 g of the below-described ethylenic-double-bond-containing compound as shown in Table 2, and 0.12 g of “Pionin A-41 C” (trade name; product of Takemoto Oil & Fat) were dissolved in 16.67 g of ethyl acetate. As an aqueous phase component, 37.5 g of a 4 mass % aqueous solution of PVA-205 was prepared. The oil phase component and the aqueous phase component were mixed, followed by emulsification in a homogenizer at 12,000 rpm for 10 minutes. The emulsion thus obtained was added to 25 g of distilled water. After stirring at room temperature for 30 minutes, stirring was conducted further at 40° C. for 2 hours. The microcapsule solution (1) thus obtained was diluted with distilled water to give its solid concentration of 15 mass %. The microcapsule thus obtained had an average particle size of 0.2 μm.

(4) Exposure and Printing

The resulting lithographic printing plate precursor was exposed using “Trendsetter 3244 Vx” (trade name; product of Creo Inc.) equipped with a water-cooling type 40W infrared semiconductor laser at an output of 9 W, an external drum speed of 210 rpm, and a resolution of 2,400 dpi. The image to be exposed included a line chart. The exposed plate was mounted on the cylinder of a printing press “SOR-M” (trade name; product of Heidelberger Druckmaschinen A G) without the development treatment After fountain solution (“EU-3”, trade name of an etchant; product of Fuji Photo Film)/water/isopropyl alcohol=1/89/10 by volume) and black ink “TRANS-G (N)” (trade name; product of Dainippon Ink and Chemicals) were supplied to the plate, 100 impressions were printed at a press speed of 6,000 impressions per hour.

The number of sheets of printing paper required until the transfer of the ink to the printing paper stopped, after completion of the on-press development of unexposed areas of the image recording layer, was measured as the on-press developability. In any of the lithographic printing plate precursors, impressions free of contamination in non-image areas were obtained within 100 sheets.

(5) Evaluation

Generally, when the exposure amount of a negative-type lithographic printing plate precursor is small, the curing degree of an image recording layer (photosensitive layer) lowers, while the curing degree increases at a greater exposure amount. If the curing degree of the image recording layer is too low, the lithographic printing plate has lowered printing durability and reproduction of dots and fine lines becomes poor. On the other hand, when the curing degree of the image recording layer is high, the printing durability increases and dots and fine lines are reproduced well.

In these Examples, as indicated below, the printing durability and fine line reproduction of the lithographic printing plate precursors obtained above were evaluated under the same exposure amount conditions as mentioned above. The fine line reproduction was used as an indicator of the sensitivity of the lithographic printing plate precursor. In other words, the lithographic printing plate precursor can be said to have a higher sensitivity when the number of impressions in the printing durability test is greater and the line width in the fine line reproduction test is smaller.

(i) Fine Line Reproduction:

As described above, after printing 100 impressions and confirming that impressions had no ink contamination in non-image areas, the print run was continued for another 500 impressions. The line chart (chart in which fine lines having widths of 10, 12, 14, 16, 18, 20, 25, 30, 35, 40, 60, 80, 100 and 200 μm were exposed) on the 600th impression was observed by a 25× magnifier and the fine line reproduction was rated based on the widths of the fine lines that were reproduced in ink without any breaks. The lithographic printing plate precursor capable of reproducing the line width not greater than 10 μm is evaluated as A, while that capable of reproducing the line width not greater than 16 μm is evaluated as B. The results are shown in Table 2.

(ii) Printing Durability

After printing for evaluation of the fine line reproduction as described above, printing was continued further. As the number of impressions rose, the image recording layer was gradually worn and ink receptivity declined, leading to a decrease in the ink density on the printing paper. The printing durability was evaluated based on the number of impressions at which the ink density (reflection density) decreased by 0.1 from that upon starting of the printing. The results are shown in Table 2.

TABLE 2

| | | | | Microcapsule | | | | | |
|---|---|---|---|---|---|---|---|---|---|
| | | | Polymerizable | Ethylenic- double- | Fine-line reproduction | | | | Printing |
| | Polymer binder | | monomer | bond-containing | (mJ/cm²) | | | | durability |
| | Comp'd | Amount | Amount | compound | 70 | 100 | 150 | 200 | (150 mJ/cm²) |
| Ex. 18 | (1) | 0.162 g | 0.385 g | (A) | A | A | A | A | 30000 |
| Ex. 19 | (1) | 0.342 g | 0.205 g | (A) | A | A | A | A | 27000 |
| Ex. 20 | (1) | 0.342 g | 0.205 g | (B) | A | A | A | A | 28000 |
| Ex. 21 | (2) | 0.342 g | 0.205 g | (A) | A | A | A | A | 30000 |
| Ex. 22 | (2) | 0.342 g | 0.205 g | (B) | A | A | A | A | 30000 |
| Ex. 23 | (2) | 0.162 g | 0.385 g | (A) | A | A | A | A | 32000 |
| Comp. | (1) | 0.162 g | 0.385 g | None | B | A | A | A | 20000 |
| Ex. 3 | | | | | | | | | |

As is apparent from Table 2, the lithographic printing plate precursors (Examples 18 to 23) of the invention are superior in fine line reproduction and printing durability to the conventional lithographic printing plate precursor (Comparative Example 3). The results suggest that the lithographic printing plate precursors of the invention have good sensitivity and permits printing of a great number of good impressions at a practical energy amount.

By the invention, it is possible to provide a lithographic printing plate precursor permitting printing of a large number of good impressions at a practical energy amount, and at the same time having excellent on-machine developability; and a lithographic printing plate using the printing plate precursor.

The entire disclosure of each and every foreign patent application from which the benefit of foreign priority has been claimed in the present application is incorporated herein by reference, as if fully set forth.

1. A lithographic printing plate precursor comprising:
a support; and
an image recording layer that contains image forming particles and a non-water-soluble binder, the non-water-soluble binder interacting with the surface of the image forming particles.

2. A lithographic printing plate precursor according to claim 1,
wherein each of the image forming particles comprises a particle dispersant adjacent to the surface of said each of the the image forming particles, the particle dispersant interacting with the non-water-soluble binder.

3. A lithographic printing plate precursor according to claim 1, wherein the image forming particles are microcapsules.

4. A lithographic printing plate precursor according to claim 3, wherein each of the microcapsules internally contains a thermoreactive-group-containing compound and an infrared absorber.

5. A lithographic printing plate precursor according to claim 1, wherein the non-water-soluble binder is an organic polymer.

6. A lithographic printing plate precursor according to claim 5, wherein the organic polymer comprises a polar substituent.

7. A lithographic printing plate precursor according to claim 2,
wherein the non-water-soluble binder is an organic polymer, and wherein a difference in a I/O value between the particle dispersant and the organic polymer is 1.6 or less.

8. A lithographic printing plate precursor according to claim 1, which can be developed on a printing press by at lease one of a printing ink and a fountain solution.

9. A lithographic printing plate precursor comprising:
a support; and
an image recording layer that contains a polymer binder and particles, wherein the particles are microcapsules having a polymerizable functional group as a wall material.

10. A lithographic printing plate precursor according to claim 9,
wherein the image recording layer further comprises an infrared absorber, a polymerization initiator and a polymerizable compound, in which the image recording layer permits imagewise recording by exposure to an infrared laser so as to form an exposed area and an unexposed area,
and wherein printing is performed by removing, after imagewise exposing, the unexposed area by feeding an oil based ink and an aqueous component.

11. A lithographic printing plate precursor according to claim 9, wherein the polymer binder has a polymerizable functional group.

12. A lithographic printing plate precursor according to claim 1, wherein the non-water-soluble binder is an inorganic polymer.

13. A lithographic printing plate precursor according to claim 12, wherein the non-water-soluble binder is a particulate inorganic polymer having a hydrophobized surface.

14. A lithographic printing method comprising:
mounting a lithographic printing plate precursor according to claim 1 on a printing press;
imagewise exposing the lithographic printing plate precursor with an infrared laser to form an exposed portion and an unexposed portion;
feeding at least one of an printing ink and aqueous component to the lithographic printing plate precursor, to remove the unexposed portion; and
starting printing.

15. A lithographic printing method according to claim 14, wherein the mounting is peformed before the imagewise exposing.

16. A lithographic printing method according to claim 14, wherein the mounting is peformed after the imagewise exposing.
